(19) United States
(12) Patent Application Publication
(10) Pub. No.: US 2024/0043636 A1
(43) Pub. Date: Feb. 8, 2024

(54) PREPREG AND CARBON FIBER-REINFORCED COMPOSITE MATERIAL

(71) Applicant: Toray Composite Materials America, Inc., Tacoma, WA (US)

(72) Inventors: Alfred P. Haro, Tacoma, WA (US); Jonathan C. Hughes, Tacoma, WA (US); Naoki Matsuura, Tacoma, WA (US); Jeffrey P. Sitthi, Tacoma, WA (US); Hiroshi Kobayashi, Tacoma, WA (US); Toshiya Kamae, Tacoma, WA (US)

(73) Assignee: Toray Composite Materials America, Inc., Tacoma, WA (US)

(21) Appl. No.: 18/039,850

(22) PCT Filed: Dec. 2, 2021
(86) PCT No.: PCT/US2021/061617

§ 371 Date: Jun. 1, 2023

Related U.S. Application Data
(60) Provisional application No. 63/121,628, filed on Dec. 4, 2020.

(51) Int. Cl. C08J 5/24

(52) U.S. Cl. CPC C08J 5/243; C08J 2335/00

(57) ABSTRACT

A prepreg is provided. The prepreg includes sizing agent-coated carbon fibers and a thermosetting resin composition (B) impregnated between the sizing agent-coated carbon fibers. The sizing agent includes a reactive component (A) having at least three reactive groups per molecule: (i) two or more first functional groups capable of reacting with the thermosetting resin composition (B), and (ii) at least one second functional group different from the two or more first functional groups (i). The second functional group includes at least one of amide, imide, urethane, urea, carbonyl, ester, sulfonyl, aromatic ring, or combinations thereof. The thermosetting resin composition (B) includes at least one thermosetting resin other than an epoxy resin and has a glass transition temperature of 220° C. or more after being cured.

### CROSS-REFERENCE TO RELATED APPLICATION

This application claims priority to U.S. Provisional Application No. 63/121,628, filed Dec. 4, 2020, titled PREPREG AND CARBON FIBER-REINFORCED COMPOSITE MATERIAL, incorporated herein by reference.

### FIELD OF THE INVENTION

The present invention relates to a prepreg and a fiber-reinforced composite material, e.g., a carbon fiber-reinforced composite material. More specifically, the present disclosure provides a prepreg including a sizing agent-coated carbon fibers, which is well suited for use with high heat-resistant thermosetting resin compositions for fiber reinforced composite materials that are well suited for aerospace applications and general industrial applications.

### BACKGROUND

Fiber-reinforced Composite (FRC) materials comprising a reinforced fiber and a matrix resin have excellent mechanical properties such as strength and rigidity while also being lightweight, and therefore are widely used as aircraft members, spacecraft members, automobile members, railway car members, ship members, sports apparatus members, and computer members such as housings for laptops. The FRC materials are produced by various methods; a widely practiced method is to use reinforcing fibers impregnated with an unhardened matrix resin, as a prepreg. In this method, sheets of prepreg are laminated and heated, to form a composite material. The matrix resins used for prepregs include both thermoplastic resins and thermosetting resins. In most cases, thermosetting resins are excellent in terms of ease of handling. In higher temperature use areas or where high performance is needed over a larger temperature window, the matrix systems used are bismaleimide (BMI) resins and benzoxazine (BOX) resins that can withstand the high use temperatures, while still providing superior mechanical performance.

The FRCs' properties depend on the reinforcement fibers, any sizing agents on the reinforcement fiber, and the matrix resin. The important design properties include tensile strength and modulus, compression strength and modulus, impact resistance, damage tolerance, interlaminar shear strength, and toughness. In general, in FRC materials, the reinforcing fibers contribute to the majority of these properties. However, the adhesion between the reinforcing fibers and the matrix resin has an effect on properties such as interlaminar shear strength and toughness. This adhesion between the reinforcing fibers and the matrix is affected by the sizing agents and their interaction with the matrix. On the other hand, the matrix resin has greatest impact on compression strength and transverse tensile properties. When the FRC materials are used as structural materials, interlaminar shear strength and compression strength are especially important properties. Therefore, superior properties can be obtained when the matrix resin and the reinforcing fiber each have excellent properties alone, but also have good adhesion between them, which is typically improved by the use of sizing agents.

However, a problem associated with presently available sizing agents and higher-heat resistant matrix materials (those having a Tg of 220° C. or higher) is that they tend to be incompatible with each other. Another difficulty associated with presently available sizing agents, is that they may degrade at the higher use temperatures of the parts that include the high heat-resistant resins. Yet another problem is that the sizing agents may degrade or bonds formed between the sizing agents and the heat-resistant resin may degrade either at the use temperature of the parts or at the temperatures needed to cure the high heat-resistant resins. This degradation or incompatibility is manifested by reduced mechanical properties, such as poor interlaminar shear strength of the cured composite.

Currently, a solution to this problem of incompatibility or degradation is to use mainly sizing agent-free (uncoated) carbon fibers for high heat-resistant thermosetting resin matrix systems, such as the BMI resins and the BOX resins, to make prepregs. Not including a sizing agent contributes to a high Thermal Oxidative Stability (TOS) for the carbon fibers that is compatible with the TOS of the high heat-resistant thermosetting resin matrix systems. However, from a processing and quality perspective, the resultant carbon fiber prepreg that is produced from the uncoated fibers shows an increase in fuzz. This increase in fuzz is a processing problem and also tends to reduce the overall quality of the prepreg, which in turn relates directly to reduced mechanical properties, ease of handling and ease of production. Previous efforts to use sizing agents to solve this problem using different sizing agents has shown degradation in two important properties: TOS and/or adhesion. In the past, sizing agents that increased the TOS of both the carbon fiber and the cured CFRP (carbon fiber-reinforced plastic) made of the prepreg reduced the overall adhesion of the fiber to the high heat-resistant thermosetting resin matrix systems due to either incompatibility with the carbon fiber or incompatibility with the high heat-resistant thermosetting resin matrix systems. This reduced adhesion is manifested in lower interlaminar shear strength. Other attempts to increase compatibility between the sizing agents and the high temperature matrix systems, while keeping good adhesion to the carbon fiber, has resulted in a loss of TOS, thus reducing the overall use temperature of the CFRP produced from such prepregs. Still other attempts at high TOS sizing agents have used long chain thermoplastic materials that do not allow for the use of environmentally friendly solvents such as water. Most of the high heat-resistant thermosetting resin matrix systems come with a very high cost, but due to the reduced use temperatures caused by the lowered TOS of the carbon fibers with these sizing agents, these costs cannot be justified in the design of new aerospace parts.

The present invention has been made taking the above matters into account, and has an objective (among others) of providing a prepreg with a sizing agent-coated carbon fiber that is well suited for use with high heat-resistant thermosetting resin compositions. These sizing agents also provide coated carbon fibers that are resistant to being fluffed and broken when rubbed by guide rollers and sophisticated processing equipment during the manufacture of prepreg materials, while also creating good adhesion to the matrix resins, such as BMI resins and BOX resins. Further, these sizing agents maintain good TOS of the mechanical properties of finished composite materials, when exposed to high temperatures. The sizing agent's effectiveness is manifested by the improved interlaminar shear strength of cured parts made from the prepregs and carbon fibers including the sizing agents.

### SUMMARY OF THE INVENTION

To solve the aforementioned problem, the present inventors have discovered that utilizing sizing agent-coated carbon fiber coated with a specific type of sizing agents in the high heat-resistant thermosetting resin composition achieves an excellent quality of prepreg due to reduced fiber fuzz and breakage, a carbon fiber-reinforced composite material with good adhesion properties between the carbon fiber and the high heat-resistant thermosetting resin composition, and high TOS.

This invention provides a prepreg comprising, consisting of or consisting essentially of sizing agent-coated carbon fibers and a high heat-resistant thermosetting resin composition (B) impregnated between the sizing agent-coated carbon fibers. The sizing agent is comprised of a reactive component (A) having (i) two or more first functional groups capable of reacting with the high heat-resistant thermosetting resin composition (B), and (ii) at least one second functional group, different from the first functional groups (i), selected from the group consisting of amide, imide, urethane, urea, carbonyl, ester, sulfonyl, aromatic ring, or combination thereof. The high heat-resistant thermosetting resin composition (B) is comprised of at least one thermosetting resin other than an epoxy resin and has a glass transition temperature of 220° C. or more after being cured. According to certain embodiments, the (i) first and (ii) second functional groups may be combined, particularly in the case of the aromatic ring. For example, an epoxy group of the first functional group (i) may be bound to an aromatic ring of the second functional group (ii).

In an aspect, a carbon fiber-reinforced composite material obtained by curing a prepreg as disclosed hereinabove is provided.

### DETAILED DESCRIPTION OF EMBODIMENTS OF THE INVENTION

All publications, patents, and patent applications cited in this specification are hereby incorporated by reference in their entirety for all purposes.

The articles “a” and “an” are used herein to refer to one or to more than one (i.e., to at least one) of the grammatical object of the article. By way of example, “a polymer resin” means one polymer resin or more than one polymer resin. Any ranges cited herein are inclusive. The terms “substantially” and “about” used throughout this specification are used to describe and account for small fluctuations. For example, they can refer to amounts or quantities that differ from a stated value by less than or equal to ±5%.

Reference throughout this specification to “one embodiment” or “an embodiment” means that a particular feature, structure, or characteristic described in connection with the embodiment is included in at least one embodiment. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more embodiments.

Unless otherwise specified, “room temperature” as used herein refers to a temperature of 25° C.

As used herein, the term PHR means “parts per hundred resin”, and accounts for only the reactive portion of the resin formulation (i.e., the components of the resin formulation which undergo a chemical reaction when the resin formulation is cured, e.g., bismaleimides and comonomers or benzoxazines and epoxy resins).

As used herein, the term, “fiber-reinforced composite material” is used interchangeably with the terms “fiber-reinforced composite,” “fiber-reinforced polymer material,” “fiber-reinforced polymer,” “fiber-reinforced plastic material,” “fiber-reinforced plastic,” and “carbon fiber reinforced polymer.”

As used herein, the term “high temperature resistant” with reference to a prepreg or a composite, means a prepreg or a composite that includes a thermosetting resin having a glass transition temperature (Tg) of 220° C. or more after curing, measured according to the procedure described in the examples set forth herein. The term “high temperature resistant” with reference to a thermosetting resin means a thermosetting resin having a glass transition temperature (Tg) of 220° C. or more after curing, measured according to the procedure described in the examples set forth herein.

The present invention relates to a prepreg and a fiber-reinforced composite material, e.g., a carbon fiber-reinforced composite material. More specifically, the present disclosure provides a prepreg with a sizing agent-coated carbon fiber that is well suited for use with high heat-resistant thermosetting resin compositions for fiber reinforced composite materials that are well suited for aerospace applications and general industrial applications.

In accordance with the present disclosure, a prepreg with sizing agent-coated carbon fibers can be obtained that has excellent quality due to reduced fiber fuzz and breakage. Moreover, by using the prepreg of the present disclosure, a carbon fiber-reinforced composite material with good adhesion properties between carbon fiber and high heat-resistant thermosetting resin matrix systems means that excellent thermal stability can be obtained by curing this prepreg. Such fiber-reinforced composite materials manifest superior mechanical properties.

The prepreg, and the carbon fiber-reinforced composite material of the present disclosure are described in detail below.

As a result of extensive research in view of the difficulties described above, the inventors have discovered that the aforementioned problems are resolved by employing, in fiber-reinforced composite material applications, a prepreg comprising sizing agent-coated carbon fibers and a high heat-resistant thermosetting resin composition (B) impregnated between the sizing agent-coated carbon fibers. The sizing agent comprises, consists of, or consists essentially of a reactive component (A) having (i) two or more first functional groups per molecule capable of reacting with the high heat-resistant thermosetting resin composition (B), and (ii) at least one second functional group per molecule comprising at least one of amide, imide, urethane, urea, carbonyl, ester, sulfonyl, aromatic ring, or combinations thereof. The first (i) and second (ii) functional groups are different from each other. The at least two first functional groups (i) may be the same or different from each other, as long as they are different from the second functional group (ii). The high heat-resistant thermosetting resin composition (B) comprises at least one thermosetting resin other than an epoxy resin and has a glass transition temperature of 220° C. or more after being cured.

Hereinafter, embodiments of a prepreg and a carbon fiber-reinforced composite material obtained by curing the prepreg of the present invention will be described in more detail. The present invention is a prepreg including sizing agent-coated carbon fibers coated with a sizing agent and a high heat-resistant thermosetting resin. The sizing agent is characterized by being comprised of the reactive component (A) having (i) two or more first functional groups per molecule capable of reacting with the high heat-resistant thermosetting resin composition (B), and (ii) at least one group selected from the groups consisting of amide, imide, urethane, urea, carbonyl, ester, sulfonyl, aromatic ring, or combinations thereof, wherein the high heat-resistant thermosetting resin has a glass transition temperature of 220° C. or more after being cured. First, the sizing agent-coated carbon fibers coated with the sizing agent comprised of the reactive component (A) having (i) two or more first functional groups capable of reacting with the high heat-resistant thermosetting resin composition (B), and (ii) at least one second group comprising at least one of amide, imide, urethane, urea, carbonyl, ester, sulfonyl, aromatic ring structure, or combinations thereof will be described.

### Reactive Component (A)

The reactive component (A) used in the present invention is a compound having (i) two or more first functional groups per molecule capable of reacting with the high heat-resistant thermosetting resin composition (B), and (ii) at least one second functional group comprising at least one of amide, imide, urethane, urea, carbonyl, ester, sulfonyl, aromatic ring, or combinations thereof in the molecule.

Without wishing to be bound by any particular theory, if there are fewer than two of the first functional groups (i) per molecule, there is a possibility that adhesion properties of a composite material obtained by curing the prepreg of the present invention might not sufficiently improve since the number of functional groups capable of reacting with the high heat-resistant thermosetting resin composition (B) is too small.

In an embodiment of the present invention, the reactive component (A) can be cross-linked to suppress diffusion into a matrix resin.

In certain embodiments of the present invention, the reactive component (A) has three or more first functional groups (i) in the molecule. The reactive component (A) may have three or more first functional groups (i), which can provide the benefit of improving the adhesion properties such as Interlaminar Shear Strength (ILSS).

Not to be bound by theory, it is thought that the at least one second functional group (ii) comprising at least one of amide, imide, urethane, urea, carbonyl, ester, sulfonyl, aromatic ring, or combinations thereof in the reactive component (A) molecule provides good adhesion between a sizing agent and a carbon fiber.

### Examples of First Functional Groups (i) on Reactive Component (A)

The first functional groups (i) capable of reacting with the high heat-resistant thermosetting resin composition (B) can be selected from those capable of participating in a free radical reaction, such as vinyl groups, acryloyl groups, methacryloyl groups, halogen-containing groups, azo groups, or peroxide groups.

In another embodiment, the first functional groups (i) can be selected from hydroxybenzyl groups, hydroxyphenoxy groups, phenoxy groups, phenolic hydroxyl groups, epoxy groups, carboxyl groups, or amino groups.

In an embodiment, the first functional groups (i) can be preferably selected from vinyl groups, acryloyl groups, methacryloyl groups, or epoxy groups from the viewpoint of the stability and handling convenience of the sizing agent in being coated on the carbon fiber surfaces, as well as suitable reactivity with high heat-resistant thermosetting resin composition (B).

In another embodiment, the reactive component (A) may include a single type or two or more types of the first functional groups (i).

### Component (A) Having Epoxy Groups

There are no specific limitations or restrictions on the reactive component (A) having epoxy groups as the first functional group (i) used in the present invention, as long as it has at least one second functional group (ii) comprising at least one of amide, imide, urethane, urea, carbonyl, ester, sulfonyl, aromatic ring, or combinations thereof, in addition to the epoxy group.

In an embodiment, an aromatic epoxy compound can be preferably used for the reactive component (A) having the aromatic ring structure. In this case, at least one of the two first functional groups (i) is an epoxy group and the second functional group (ii) is the aromatic ring. In the present invention, the aromatic epoxy compound is preferably an epoxy compound having two or more types of first functional groups (i), where the number of the functional groups (i) is three or more and at least one of them is the epoxy group. The aromatic epoxy compound is more preferably an epoxy compound having two or more types of first functional groups (i). The number of the first functional groups (i) may be four or more. The second functional group (ii) of the aromatic epoxy compound is preferably, in addition to the aromatic ring, a functional group comprising at least one of an amide group, an imide group, a urethane group, a urea group, or a sulfonyl group. Without wishing to be bound by any particular theory, it is thought that in an aromatic epoxy compound having three or more epoxy groups or having an epoxy group and two or more other first functional groups (i) in the molecule, even when one epoxy group forms a covalent bond with an oxygen-containing functional group on the surface of the carbon fiber, two or more of the remaining epoxy groups or other of the first functional groups (i) may form a covalent bond or a hydrogen bond with the matrix resin. This ability to bond with both the carbon fibers and the matrix resin may further improve the adhesion. Although the upper limit of the number of first functional groups (i) including epoxy groups is not particular limited, a compound having ten first functional groups (i) per molecule is sufficient for adequate adhesion.

In another embodiment, the aromatic epoxy compound preferably has an epoxy equivalent of less than 360 g/eq., more preferably less than 270 g/eq., and even more preferably less than 180 g/eq. Without wishing to be bound to any particular theory, an aromatic epoxy compound having an epoxy equivalent of less than 360 g/eq. may form a high density of covalent bonds, thus further improving the adhesion between carbon fibers and a matrix resin. Although the lower limit of the epoxy equivalent is not particularly limited, an aromatic epoxy compound having an epoxy equivalent of 90 g/eq. or more is sufficient for the adhesion.

Examples of suitable aliphatic epoxy compounds as component (A), include but are not limited to: glycidyl ether epoxy compounds derived from aromatic polyols, glycidylamine epoxy compounds derived from aromatic amines having a plurality of active hydrogens, glycidyl ester epoxy compounds derived from aromatic polycarboxylic acids, and epoxy compounds obtained by oxidation of aromatic compounds having a plurality of double bonds in the molecule, and the like.

Examples of the glycidyl ether epoxy compound include but are not limited to; a glycidyl ether epoxy compound obtained by reaction of epichlorohydrin with a compound selected from bisphenol A, bisphenol F, bisphenol AD, bisphenol S, tetrabromobisphenol A, phenol novolac, cresol novolac, hydroquinone, resorcinol, 4,4′-dihydroxy-3,3′,5,5′-tetramethylbiphenyl, 1,6-dihydroxynaphthalene, 9,9-bis(4-hydroxyphenyl)fluorene, tris(p-hydroxyphenyl)methane, and tetrakis(p-hydroxyphenyl)ethane. The glycidyl ether epoxy compound is also exemplified by a glycidyl ether epoxy compound having a biphenylaralkyl skeleton.

Examples of the glycidylamine epoxy compound include N,N-diglycidylaniline, N,N-diglycidyl-o-toluidine, and glycidyl ether epoxy compounds obtained by reaction of epichlorohydrin with a compound selected from m-xylylenediamine, m-phenylenediamine, 4,4′-diaminodiphenylmethane, and 9,9-bis(4-aminophenyl)fluorene.

The glycidylamine epoxy compound is also exemplified by an epoxy compound obtained by reaction of epichlorohydrin with both a hydroxyl group and an amino group of an aminophenol such as m-aminophenol, p-aminophenol, and 4-amino-3-methylphenol.

Examples of the glycidyl ester epoxy compound include glycidyl ester epoxy compounds obtained by reaction of epichlorohydrin with phthalic acid, terephthalic acid, and hexahydrophthalic acid.

Examples of the aromatic epoxy compound used in the present invention include, in addition to the above example epoxy compounds, epoxy compounds synthesized from the epoxy compounds exemplified above as a raw material, and the epoxy compound is exemplified by an epoxy compound synthesized by an oxazolidone ring formation reaction of bisphenol A diglycidyl ether and tolylene diisocyanate.

In certain embodiments of the present invention, the aromatic epoxy compound preferably has, in addition to one or more epoxy groups (i), at least one or more second functional groups (ii) selected from an amide group, an imide group, a urethane group, a urea group, a sulfonyl group, a carboxy group, an ester group, a sulfonyl group, or combinations thereof. Non-limiting examples of such compounds include compounds having an epoxy group and an amide group, compounds having an epoxy group and an imido group, compounds having an epoxy group and a urethane group, compounds having an epoxy group and a urea group, and compounds having an epoxy group and a sulfonyl group.

Non-limiting examples of the aromatic epoxy compound having an amide group in addition to an epoxy group include glycidylbenzamide and amide-modified epoxy compounds. The amide-modified epoxy can be obtained by reaction of a carboxy group of a dicarboxylic amide containing an aromatic ring with an epoxy group of an epoxy compound having two or more epoxy groups.

The aromatic epoxy compound having a urethane group in addition to an epoxy group can be prepared by reacting the terminal hydroxyl group of a polyethylene oxide monoalkyl ether with a polyvalent isocyanate having an aromatic ring in an amount equivalent to that of the hydroxyl group and then reacting the isocyanate residue of the obtained reaction product with a hydroxyl group of a polyvalent epoxy compound. Non-limiting examples of the polyvalent isocyanate used here include 2,4-tolylene diisocyanate, m-phenylene diisocyanate, p-phenylene diisocyanate, diphenylmethane diisocyanate, triphenylmethane triisocyanate, and biphenyl-2,4,4′-triisocyanate.

Non-limiting examples of the aromatic epoxy compound having a urea group in addition to an epoxy group include urea-modified epoxy compounds. The urea-modified epoxy can be prepared by reacting a carboxy group of a dicarboxylic acid urea with an epoxy group of an aromatic ring-containing epoxy compound having two or more epoxy groups.

A non-limiting example of the aromatic epoxy compound having a sulfonyl group in addition to an epoxy group include bisphenol S epoxy.

In the present invention, the aromatic epoxy compound is preferably any of a phenol novolac epoxy compound, a cresol novolac epoxy compound, and tetraglycidyldiaminodiphenylmethane. These epoxy compounds have a large number of epoxy groups, a small epoxy equivalent, and two or more aromatic rings, thus improve the adhesion between carbon fibers and a matrix resin, and also improve the mechanical characteristics such as 0° tensile strength of a fiber-reinforced composite material. The aromatic epoxy compound is more preferably a phenol novolac epoxy compound and a cresol novolac epoxy compound.

In the present invention, the aromatic epoxy compound is preferably a phenol novolac epoxy compound, a cresol novolac epoxy compound, tetraglycidyldiaminodiphenylmethane, a bisphenol A epoxy compound, or a bisphenol F epoxy compound from the viewpoint of the stability of a prepreg during long-term storage and adhesiveness, and is more preferably a bisphenol A epoxy compound or a bisphenol F epoxy compound.

The sizing agent used in the present invention may further include one or more additional components in addition to at least one of an aliphatic epoxy compound and an aromatic epoxy compound. For example, including an adhesion promoting component that improves the adhesion between the carbon fibers and the sizing agent described herein or including a material that imparts bendability or flexibility to the sizing agent-coated carbon fibers, the additional component may increase ease of handling, abrasion resistance, and fuzz resistance and can improve the impregnation properties of a matrix resin into the carbon fibers. In the present invention, in order to improve the long-term stability of a prepreg, the sizing agent may contain additional compounds other than the aliphatic epoxy compound and the aromatic epoxy compound. The sizing agent may contain auxiliary components such as a dispersant and/or a surfactant in order to stabilize the sizing agent.

Without wishing to be bound by any theory, it is preferable that the epoxy compound used as the reactive component (A) having epoxy groups is selected from an aromatic epoxy compound, an epoxy compound having the hydantoin structure, an epoxy compound having an isocyanurate structure and mixtures thereof, from the view point of heat-resistance of the composite material obtained by curing the prepreg of the present invention.

### Component (A) Having Vinyl, Acryloyl, Methacryloyl Groups

There are no specific limitations or restrictions on the reactive component (A) having as functional groups (i) vinyl groups, acryloyl groups, and/or methacryloyl groups used in the present invention

For example, suitable compounds (A) may include functional groups (i) selected from vinyl, acryloyl and methacryloyl groups as part of monomers formed by reactions of unsaturated carboxylic acids and polyols; unsaturated carboxylic acids and polyols; and polymers of such monomers. The unsaturated alcohols which can be used here include olefin alcohols, reaction products between an unsaturated carboxylic acid and a polyol, for example. The olefin alcohols may include, for example, allyl alcohol, crotyl alcohol, 3-butene-1-ol, 3-butene-2-ol, 3-pentene-1-ol, 4-pentene-1-ol, 4-pentene-2-ol, 4-hexene-1-ol, 5-hexene-1-ol. Olefinic alcohols with the unsaturated groups at the ends are preferably suitable for enhancing the number-average molecular weight, which will be described later. The reaction products between an unsaturated carboxylic acid and a polyol include, for example, 2-hydroxyethyl (meth)acrylate, 2-hydroxypropyl (meth)acrylate, 2-hydroxybutyl (meth)acrylate, 2-hydroxy-3-phenoxypropyl (meth)acrylate, 2-(meth)acryloyloxyethylphthalic acid, 2-hydroxy-3-(meth)acryloyloxypropyl (meth)acrylate, ethylene glycol mono(meth)acrylate, diethylene glycol mono(meth)acrylate, polyethylene glycol mono(meth)acrylate, polypropylene glycol mono(meth)acrylate, polyethylene glycol polypropylene glycol mono(meth)acrylate, 1,6-hexanediol mono(meth)acrylate, neopentyl glycol mono(meth)acrylate, trimethylolpropane di(meth)acrylate, bisphenol A diglycidyl ether (meth)acrylic acid addition product, and the like. A reaction product between an unsaturated carboxylic acid and a polyol can be preferably used as the component (A).

The unsaturated carboxylic acids which can be used here to form the component (A) include acrylic acid, methacrylic acid, oleic acid, maleic acid, fumaric acid, itaconic acid, for example. The polyols which can be preferably used here include, for example, glycerol, ethylene glycol, diethylene glycol, polyethylene glycol, polypropylene glycol, polyalkylene glycol, arabitol, sorbitol, 1,6-hexanemethylene diol, and the like.

The isocyanate compounds as functional groups (i) which can be used here to form the component (A) include, for example, isocyanate compounds such as tolylene diisocyanate, ditolylene diisocyanate, diphenylmethane diisocyanate, dimethyldiphenylmethane diisocyanate, hexamethylene diisocyanate, metaphenylene diisocyanate, propyl isocyanate, and butyl isocyanate.

Any of the above unsaturated alcohols or any of the above unsaturated carboxylic acids and any of the above isocyanate compounds are properly combined to form the component (A), and suitable reaction conditions are selected from known reaction conditions to form urethanes. After completion of reaction, the reaction solvent is removed, to easily obtain the intended compound as component (A).

As the reaction product, i.e., component (A), an unsaturated polyurethane compound with acrylate groups and methacrylate groups as the unsaturated groups (i) at the ends is preferable, and at least one compound selected from phenylglycidyl ether acrylate hexamethylene diisocyanate, phenylglycidyl ether acrylate tolylene diisocyanate, pentaerythritol acrylate hexamethylene diisocyanate, phenylglycidyl ether triacrylate isophorone diisocyanate, glycerol dimethacrylate tolylene diisocyanate, glycerol dimethacrylate isophorone diisocyanate, pentaerythritol triacrylate tolylene diisocyanate, pentaerythritol triacrylate isophorone diisocyanate and triallyl isocyanurate can be used.

If present, it is preferable that the number of unsaturated groups is two or more per monomer, for easily and uniformly enhancing the number-average molecular weight on the carbon fiber surfaces to form a film and for reacting with the high heat-resistant thermosetting resin composition (B). Three or more unsaturated groups are more preferable. If a monomer with one unsaturated group at an end is heated and polymerized on the carbon fiber surfaces, the reaction with the high heat-resistant thermosetting resin composition (B) does not progress since the number of functional groups capable of reacting with the high heat-resistant thermosetting resin composition (B) is small, and it can happen that the adhesion properties of the composite material do not improve. To ensure the interaction with a specific quantity of functional groups on the carbon fiber surfaces when a film is formed on the carbon fiber surfaces, it is preferable that the polar group density as the number of polar groups per number-average molecular weight of the monomer is 1×10⁻³ or more per molecular weight. A polar group density of 3×10⁻³ or more per number-average molecular weight is more preferable. Usually the upper limit is 15×10⁻³ or less per number-average molecular weight, and preferable is 7×10⁻³ or less per molecular weight. It is preferable that the molecular weight of the monomer is 100 g/mole to 1,500 g/mole lower viscosity materials may be more conveniently handled as a bundling agent. A more preferable range is 500 g/mole to 1000 g/mol.

### Component (A) Having Hydroxybenzyl Groups, Hydroxyphenoxy Groups, Phenoxy Groups and Phenolic Hydroxyl Groups

There are no specific limitations or restrictions on the reactive component (A) having hydroxybenzyl groups, hydroxyphenoxy groups, phenoxy groups and phenolic hydroxyl groups, and a monomer selected from phenylglycidyl ether acrylate, hexamethylene diisocyanate, phenylglycidyl ether tolylene diisocyanate and phenylglycidyl ether isophorone diisocyanate, a polymer obtained by polymerizing the monomer, and mixtures thereof can be used.

Component (A) with Accelerator

In an embodiment, the sizing agent used in the present invention may further include an accelerator to improve the adhesion between the sizing agent-coated carbon fibers and the high heat-resistant thermosetting resin composition (B). Without wishing to be bound by any particular theory, the accelerator may promote the formation of a covalent bond between the reactive component (A) and an oxygen-containing functional group originally present on the surface of the carbon fibers or between an epoxy compound (if used) and an oxygen-containing functional group such as a carboxy group or a hydroxyl group introduced by oxidation treatment of the carbon fibers. The accelerator used in the present invention includes at least one compound can be selected from a tertiary amine compound and/or a tertiary amine salt having a molecular weight of 100 g/mole or more, a quaternary ammonium salt having a cation site represented by General Formula (I):

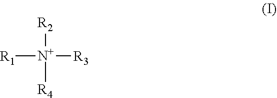

(where each of R₁ to R₄ is a C₁₋₂₂ hydrocarbon group, the hydrocarbon group optionally has a hydroxyl group, and a CH₂ group in the hydrocarbon group is optionally substituted by —O—, —O—CO—, or —CO—O—) or General Formula (II):

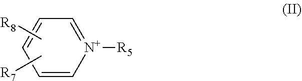

(where R₅ is a C₁₋₂₂ hydrocarbon group, the hydrocarbon group optionally has a hydroxyl group, and a CH₂ group in the hydrocarbon group is optionally substituted by —O—, —O—CO—, or —CO—O—; each of R₆ and R₇ is hydrogen or a C₁₋₈ hydrocarbon group, and a CH₂ group in the hydrocarbon group is optionally substituted by —O—, —O—CO—, or —CO—O—), and a quaternary phosphonium salt and/or a phosphine compound. In certain embodiments of the present invention, the reactive component (A) used with the accelerator can be preferably selected from a compound having two or more epoxy groups in the molecule and/or an epoxy compound having one or more epoxy groups and at least one or more functional groups (ii) selected from an amide group, an imide group, a urethane group, a urea group, and a sulfonyl group in the molecule. In another embodiment, the epoxy compound is preferably any of a phenol novolac epoxy resin, a cresol novolac epoxy resin, and tetraglycidyldiaminodiphenylmethane. These epoxy resins have a large number of epoxy groups, a small epoxy equivalent, and two or more aromatic rings and thus improve the adhesion between carbon fibers and a matrix resin and the mechanical characteristics such as 0° tensile strength of a carbon fiber-reinforced composite material. The epoxy resin having two or more functional groups is more preferably a phenol novolac epoxy resin or a cresol novolac epoxy resin.

Specific examples of the epoxy compound having two or more epoxy groups include glycidyl ether epoxy resins derived from polyols, glycidylamine epoxy resins derived from amines having a plurality of active hydrogens, glycidyl ester epoxy resins derived from polycarboxylic acids, and epoxy resins obtained by oxidation of compounds having a plurality of double bonds in the molecule.

Non-limiting examples of the glycidyl ether epoxy resin include glycidyl ether epoxy resins obtained by reaction of epichlorohydrin with bisphenol A, bisphenol F, bisphenol AD, bisphenol S, tetrabromobisphenol A, phenol novolac, cresol novolac, hydroquinone, resorcinol, 4,4′-dihydroxy-3,3′,5,5′-tetramethylbiphenyl, 1,6-dihydroxynaphthalene, 9,9-bis(4-hydroxyphenyl)fluorene, tris(p-hydroxyphenyl)methane, and tetrakis(p-hydroxyphenyl)ethane. Examples of the glycidyl ether epoxy resin also include glycidyl ether epoxy resins obtained by reaction of epichlorohydrin with ethylene glycol, diethylene glycol, triethylene glycol, tetraethylene glycol, polyethylene glycol, propylene glycol, dipropylene glycol, tripropylene glycol, tetrapropylene glycol, polypropylene glycol, trimethylene glycol, 1,2-butanediol, 1,3-butanediol, 1,4-butanediol, 2,3-butanediol, polybutylene glycol, 1,5-pentanediol, neopentyl glycol, 1,6-hexanediol, 1,4-cyclohexanedimethanol, hydrogenated bisphenol A, hydrogenated bisphenol F, glycerol, diglycerol, polyglycerol, trimethylolpropane, pentaerythritol, sorbitol, and arabitol. Additional examples of the glycidyl ether epoxy resin include glycidyl ether epoxy resins having a dicyclopentadiene structure and glycidyl ether epoxy resins having a biphenylaralkyl structure.

Non-limiting examples of the glycidylamine epoxy resin include N,N-diglycidylaniline, N,N-diglycidyl-o-toluidine, 1,3-bis(aminomethyl)cyclohexane, m-xylylenediamine, m-phenylenediamine, 4,4′-diaminodiphenylmethane, and 9,9-bis(4-aminophenyl)fluorene. Examples of the glycidylamine epoxy resin also include epoxy resins obtained by reaction of epichlorohydrin with both a hydroxyl group and an amino group of an aminophenol such as m-aminophenol, p-aminophenol, and 4-amino-3-methylphenol.

Non-limiting examples of the glycidyl ester epoxy resin include glycidyl ester epoxy resins obtained by reaction of epichlorohydrin with phthalic acid, terephthalic acid, hexahydrophthalic acid, and a dimer acid.

Non-limiting examples of the epoxy resin as reactive component (A) obtained by oxidation of a compound having a plurality of double bonds in the molecule include epoxy resins having an epoxycyclohexane ring in the molecule. Examples of the epoxy resin further include epoxidized soybean oil.

In addition to these epoxy resins, the epoxy compound as reactive component (A) used in the present invention is exemplified by epoxy resins such as triglycidyl isocyanurate. Examples of the epoxy compound further include epoxy resins synthesized from the epoxy resins exemplified above as a raw material, including epoxy resins synthesized by an oxazolidone ring formation reaction of bisphenol A diglycidyl ether and tolylene diisocyanate.

In the present invention, specific examples of the epoxy compound as reactive component (A) having one or more epoxy groups and at least one or more functional groups selected from, an amide group, an imide group, a urethane group, a urea group, and a sulfonyl group include compounds having an epoxy group and an amide group, compounds having an epoxy group and an imido group, compounds having an epoxy group and a urethane group, compounds having an epoxy group and a urea group, and compounds having an epoxy group and a sulfonyl group.

Non-limiting examples of the reactive component (A) having an epoxy group and an amide group include glycidylbenzamide and amide-modified epoxy resins. The amide-modified epoxy resin can be prepared by reaction of a carboxy group of a dicarboxylic amide with an epoxy group of an epoxy resin having two or more epoxy groups.

Non-limiting examples of the reactive component (A) having an epoxy group and an imido group include glycidylphthalimide. Specific examples of the compound include Denacol® EX-731 (manufactured by Nagase ChemteX Corporation).

Non-limiting examples of the reactive component (A) having an epoxy group and a urethane group include urethane-modified epoxy resins and specifically include Adeka Resin® EPU-78-135, EPU-6, EPU-11, EPU-15, EPU-16A, EPU-16N, EPU-17T-6, EPU-1348, and EPU-1395 (manufactured by ADEKA). In addition, the compound can be prepared by reacting the terminal hydroxyl group of a polyethylene oxide monoalkyl ether with a polyvalent isocyanate in an amount equivalent to that of the terminal hydroxyl group and then reacting the isocyanate residue of the obtained reaction product with a hydroxyl group of a polyvalent epoxy resin. Other non-limiting examples of the polyvalent isocyanate used here as reactive component (A) include 2,4-tolylene diisocyanate, meta-phenylene diisocyanate, para-phenylene diisocyanate, diphenylmethane diisocyanate, hexamethylene diisocyanate, isophorone diisocyanate, norbornane diisocyanate, triphenylmethane triisocyanate, and biphenyl-2,4,4′-triisocyanate.

Other examples of the reactive component (A) having an epoxy group and a urea group include urea-modified epoxy resins. The urea-modified epoxy can be prepared by reaction of a carboxy group of a dicarboxylic acid urea with an epoxy group of an epoxy resin having two or more epoxy groups.

Examples of the reactive component (A) having an epoxy group and a sulfonyl group include bisphenol S epoxies.

In certain embodiments of the present invention, the sizing agent to be used preferably includes at least one the accelerator in an amount of 0.1 to 25 parts by mass relative to 100 parts by mass of the reactive component (A).

Carbon Fiber

Examples of the carbon fibers used in the present invention include polyacrylonitrile (PAN) carbon fibers, rayon carbon fibers, and pitch carbon fibers. Among them, the PAN carbon fibers are preferably used due to excellent balance between strength and elastic modulus.

In certain embodiments of the present invention, the carbon fibers are in the form of carbon fiber bundles that preferably have a strand strength of 3.5 GPa or more, more preferably 4.0 GPa or more, and particularly preferably 5.0 GPa or more. The obtained carbon fiber bundles preferably have a strand elastic modulus of 220 GPa or more, more preferably 240 GPa or more, and particularly preferably 280 GPa or more.

In the present invention, the strand tensile strength and the elastic modulus of carbon fiber bundles can be determined by the test method of resin-impregnated strand described in JIS-R-7608 (2004) in accordance with the procedure below. The resin formulation is “Celloxide®” 2021P (manufactured by Deicel Chemical Industries, Ltd.)/boron trifluoride monoethylamine (manufactured by Tokyo Chemical Industry Co., Ltd.)/acetone=100/3/4 (parts by mass), and the hardening conditions are at normal pressure at 130° C. for 30 minutes. Ten strands of carbon fiber bundles are tested, and mean values are calculated as the strand tensile strength and the strand elastic modulus.

In certain embodiments of the present invention, the carbon fibers preferably have a surface roughness (Ra) of 6.0 to 100 nm. The surface roughness (Ra) is more preferably 15 to 80 nm and particularly preferably 30 to 60 nm. Carbon fibers having a surface roughness (Ra) of 6.0 to 60 nm have a surface with a highly active edge part, which may increase the reactivity with an epoxy group and other functional groups of reactive component (A) of the sizing agent described above, without being bound to any particular theory. Again, without being bound to a theory, the roughness may improve the interfacial adhesion, and thus such carbon fibers are preferred. Carbon fibers having a surface roughness (Ra) of 6.0 to 100 nm have an uneven surface, which can improve the interfacial adhesion due to an anchor effect of the sizing agent. Such rough carbon fibers are thus preferred.

The average roughness (Ra) of the surface of carbon fibers can be determined by using an atomic force microscope (AFM). For example, carbon fibers are cut into pieces having a length of several millimeters; then the fiber pieces are fixed onto a substrate (silicon wafer) with a silver paste; and a three-dimensional surface shape image of the central part of each single fiber is observed under an atomic force microscope (AFM). Usable examples of the atomic force microscope include NanoScope IIIa with Dimension 3000 stage system manufactured by Digital Instruments, and the observation can be performed in the following observation conditions:
Scan mode: tapping mode
Probe: silicon cantilever
Scan field: 0.6 μm×0.6 μm
Scan speed: 0.3 Hz
Number of pixels: 512×512
Measurement environment: at room temperature in the atmosphere

For each sample, in the image obtained by the observation of a single area on an individual single fiber, the curve of the fiber cross section is approximated with a three-dimensional curved surface. From the obtained whole image, the average roughness (Re) is calculated. It is preferable that the average roughness (Ra) of five single fibers be determined, and the average is evaluated.

In certain embodiments of the present invention, the carbon fibers preferably have a total fineness of 400 to 3,000 tex. The carbon fibers preferably have a filament number of 1,000 to 100,000 and more preferably 3,000 to 50,000.

In certain embodiments of the present invention, the carbon fibers preferably have a single fiber diameter of 4.5 to 7.5 μm. If having a single fiber diameter of 7.5 μm or less, the carbon-fibers can have high strength and high elastic modulus and thus are preferred. The single fiber diameter is more preferably 6 μm or less and particularly preferably 5.5 μm or less. If having a single fiber diameter of 4.5 μm or more, the carbon fibers are unlikely to cause single fiber breakage and to reduce the productivity and thus are preferred.

In certain embodiments of the present invention, the carbon fibers preferably have a surface oxygen concentration (O/C) ranging from 0.05 to 0.50, more preferably ranging from 0.07 to 0.40, particularly preferably ranging from 0.09 to 0.30, and more particularly preferably ranging from 0.12 to 0.25, where the surface oxygen concentration (O/C) is the ratio of the number of oxygen (O) atoms and that of carbon (C) atoms on the surface of the fibers and is determined by X-ray photoelectron spectroscopy. When having a surface oxygen concentration (O/C) of 0.05 or more, the carbon fibers maintain an oxygen-containing functional group on the surface of the carbon fibers and thus can achieve a strong adhesion to a matrix resin. When having a surface oxygen concentration (O/C) of 0.5 or less, the carbon fibers can suppress the reduction in strength of the carbon fiber itself by oxidation.

The surface oxygen concentration of carbon fibers is determined by X-ray photoelectron spectroscopy in accordance with the procedure below. First, a solvent is used to remove dust and the like adhering to the surface of carbon fibers; then the carbon fibers are cut into 20-mm pieces; and the pieces are spread and arranged on a copper sample holder. The measurement is carried out by using AlKα_{1,2} as the X-ray source while the inside of a sample chamber is maintained at 1×10⁻⁸ Torr. The photoelectron takeoff angle is adjusted to 90°. As the correction value for the peak associated with electrification during measurement, the binding energy value of the main peak (peak top) of Cis is set to 284.6 eV, The Cis peak area is determined by drawing a straight base line in a range from 282 to 296 eV. The O₁ₛ peak area is determined by drawing a straight base line in a range from 528 to 540 eV. The surface oxygen concentration (O/C) is expressed as an atom number ratio calculated by dividing the ratio of the Cis peak area by a sensitivity correction value inherent in an apparatus. For ESCA-1600 manufactured by Ulvac-Phi, Inc. used as the X-ray photoelectron spectrometer, the sensitivity correction value inherent in the apparatus is 2.33.

### Production Method of Carbon Fiber

A method for producing the PAN carbon fibers will next be described.

Usable examples of the spinning method for preparing precursor fibers of carbon fibers include dry spinning, wet spinning, and dry-wet spinning. To readily produce high-strength carbon fibers, the wet spinning or the dry-wet spinning is preferably employed. In particular, the dry-wet spinning is more preferably employed because carbon fibers having high strength can be produced.

As noted above, in order to further improve the adhesion between carbon fibers and a matrix resin, the carbon fibers preferably have a surface roughness (Ra) of 6.0 to 100 nm, and in order to prepare carbon fibers having such a surface roughness, the wet spinning is preferably employed to spin precursor fibers.

A spinning solution to be used may be a solution in which a homopolymer or copolymer of polyacrylonitrile is dissolved in a solvent. The solvent used is an organic solvent such as dimethyl sulfoxide, dimethylformamide, and dimethylacetamide or an aqueous solution of an inorganic compound such as nitric acid, sodium rhodanate, zinc chloride, and sodium thiocyanate. Preferred solvents are dimethyl sulfoxide and dimethylacetamide.

The spinning solution is passed through a spinneret for spinning, discharged into a spinning bath or air, and then solidified in the spinning bath. The spinning bath to be used may be an aqueous solution of the same solvent as the solvent used for the spinning solution. The spinning liquid preferably contains the same solvent as the solvent for the spinning solution, and an aqueous dimethyl sulfoxide solution and an aqueous dimethylacetamide solution are preferred. The fibers solidified in the spinning bath are subjected to water-washing and drawing to yield precursor fibers. The obtained precursor fibers are subjected to flame resistant treatment and carbonization treatment and, if desired, further subjected to graphite treatment, yielding carbon fibers. The carbonization treatment and the graphite treatment are preferably carried out under conditions of a maximum heat treatment temperature of 1,100° C. or more and more preferably 1,400 to 3,000° C.

To improve the adhesion to a matrix resin, the obtained carbon fibers are typically subjected to oxidation treatment, which introduces an oxygen-containing functional group. The oxidation treatment method may be gas phase oxidation, liquid phase oxidation, and liquid phase electrolytic oxidation, and the liquid phase electrolytic oxidation is preferably employed from the viewpoint of high productivity and uniform treatment.

In certain embodiments of the present invention, the electrolytic solution used for the liquid phase electrolytic oxidation is exemplified by an acid electrolytic solution and an alkaline electrolytic solution. From the viewpoint of adhesion, carbon fibers are more preferably subjected to the liquid phase electrolytic oxidation in an alkaline electrolytic solution and then coated with a sizing agent.

Examples of the acid electrolytic solution include inorganic acids such as sulfuric acid, nitric acid, hydrochloric acid, phosphoric acid, boric acid, and carbonic acid; organic acids such as acetic acid, butyric acid, oxalic acid, acrylic acid, and maleic acid; and salts such as ammonium sulfate and ammonium hydrogen sulfate. Among them, sulfuric acid and nitric acid, which exhibit strong acidity, are preferably used.

Examples of the alkaline electrolytic solution specifically include aqueous solutions of hydroxides such as sodium hydroxide, potassium hydroxide, magnesium hydroxide, calcium hydroxide, and barium hydroxide; aqueous solutions of carbonates such as sodium carbonate, potassium carbonate, magnesium carbonate, calcium carbonate, barium carbonate, and ammonium carbonate; aqueous solutions of hydrogen carbonates such as sodium hydrogen carbonate, potassium hydrogen carbonate, magnesium hydrogen carbonate, calcium hydrogen carbonate, barium hydrogen carbonate, and ammonium hydrogen carbonate; and aqueous solutions of ammonia, tetraalkylammonium hydroxide, and hydrazine. Among them, preferably used electrolytic solutions are aqueous solutions of ammonium carbonate and ammonium hydrogen carbonate because such a solution is free from an alkali metal that interferes with the hardening of a matrix resin, or an aqueous solution of tetraalkylammonium hydroxide exhibiting strong alkalinity is preferably used.

In certain embodiments of the present invention, the electrolytic solution preferably has a concentration ranging from 0.01 to 5 mole/L and more preferably ranging from 0.1 to 1 mole/L. If the electrolytic solution has a concentration of 0.01 mole/L or more, the electrolytic treatment can be performed at a lower electrical voltage, which is advantageous in operating cost. An electrolytic solution having a concentration of 5 mole/L, or less is advantageous in terms of safety.

In certain embodiments of the present invention, the electrolytic solution preferably has a temperature ranging from 10 to 100° C. and more preferably ranging from 10 to 40° C. An electrolytic solution having a temperature of 10° C. or more improves the efficiency of electrolytic treatment, and this is advantageous in operating cost. An electrolytic solution having a temperature of less than 100° C. is advantageous in terms of safety.

In certain embodiments of the present invention, the quantity of electricity during liquid phase electrolytic oxidation is preferably optimized depending on the carbonization degree of carbon fibers, and the treatment of carbon fibers having a high elastic modulus necessitates a larger quantity of electricity.

In certain embodiments of the present invention, the current density during liquid phase electrolytic oxidation is preferably in a range from 1.5 to 1,000 A/m² and more preferably from 3 to 500 A/m² relative to 1 m 2 of the surface area of carbon fibers in an electrolytic treatment solution. If the current density is 1.5 A/m² or more, the efficiency of electrolytic treatment is improved, and this is advantageous in operating cost. A current density of 1,000 A/m² or less is advantageous in terms of safety.

In certain embodiments of the present invention, the carbon fibers after electrolytic treatment are preferably washed with water and dried. The washing method may be dipping or spraying, for example. Among them, from the viewpoint of easy washing, the dipping is preferably employed, and the dipping is preferably performed while carbon fibers are vibrated by ultrasonic waves. An excessively high drying temperature readily causes thermal decomposition of a functional group on the outermost surface of carbon fibers, thus decomposing the functional group. The drying is thus preferably performed at a temperature as low as possible. Specifically, the drying temperature is preferably 250° C. or less and more preferably 210° C. or less. In consideration of drying efficiency, the drying temperature is preferably 110° C. or more and more preferably 140° C. or more.

### Production Method of Sizing Agent-Coated Carbon Fiber

Next, sizing agent-coated carbon fibers prepared by coating the carbon fibers with a sizing agent will be described. The sizing agent used in the present invention is comprised of the reactive component (A) having two or more functional groups (i) capable of reacting with the high heat-resistant thermosetting resin composition (B) and at least one functional group (ii) comprising at least one of amide, imide, urethane, urea, carbonyl, ester, sulfonyl and aromatic ring structure or combinations thereof; and may contain additional components.

In certain embodiments of the present invention, the method of coating carbon fibers with the sizing agent is preferably a method by single coating using a sizing agent-containing liquid in which at least one the reactive component (A) and other components are simultaneously dissolved or dispersed in a solvent and a method of multiple coating of carbon fibers using sizing agent-containing liquids in which any of the reactive component (A) and other components are selected and dissolved or dispersed in corresponding solvents. The present invention more preferably employs one step application of single coating of carbon fibers with a sizing agent-containing liquid containing all the components of the sizing agent in terms of effect and simple treatment.

The sizing agent of the present invention can be used as a sizing agent-containing liquid prepared by diluting sizing agent components with a solvent. Examples of the solvent include water, methanol, ethanol, isopropanol, acetone, methyl ethyl ketone, dimethylformamide, and dimethylacetamide. Specifically, an aqueous emulsion emulsified with a surfactant or an aqueous solution is preferably used from the viewpoint of ease of handling and safety.

In certain embodiments of the present invention, the nonionic surfactant can be one or more in combination selected from ether type surfactants such as polyoxyethylene alkyl ethers, single chain length polyoxyethylene alkyl ethers, polyoxyethylene secondary alcohol ethers, polyoxyethylene alkyl phenyl ethers, polyoxyethylene sterol ethers, polyoxyethylene lanolin derivatives, ethylene oxide derivatives of alkyl phenol formalin condensation products, polyoxyethylene polyoxypropylene block copolymer and polyoxyethylene polyoxypropylene alkyl ethers, ether ester type surfactants such as polyoxyethylene glycerol fatty acid esters, polyoxyethylene castor oil and hardened castor oil, polyoxyethylene sorbitan fatty acid esters and polyoxyethylene sorbitol fatty acid esters, and ester type surfactants such as polyethylene glycol fatty acid esters and polyglycerol fatty acid esters. Preferably used nonionic surfactants include alkylene oxide (e.g., ethylene oxide, propylene oxide or butylene oxide) addition products (block or random addition products in the case of two or more alkylene oxide addition products) of phenols selected from monocyclic phenols (phenols having one aromatic ring) such as phenol, phenols having one or more alkyl groups, and polyhydric phenols and polycyclic phenols (phenols with two or more aromatic rings) such as phenylphenol, cumylphenol, benzylphenol, hydroquinone monophenyl ether, naphthol, bisphenol, reaction products (styrenated phenols) between a monocyclic phenol or polycyclic phenol, etc. and a styrene (styrene or a-methylstyrene, etc.), etc. Among them, an ethylene oxide addition product or propylene oxide addition product of a styrenated phenol can be preferably used. The method for adding an alkylene oxide to such a phenol can be any ordinary method. It is preferable that the number of moles added is 1 to 120. A more preferable range is 10 to 90, and an especially preferable range is 30 to 80.

In addition to the nonionic surfactant, an anionic surfactant such as a carboxylate, sulfonate, sulfate or phosphate, a cationic surfactant such as an aliphatic amine salt or fatty acid quaternary ammonium salt or an amphoteric surfactant such as carboxybetaine type or aminocarboxylate can also be used for further stabilizing the emulsion.

The sizing agent-containing liquid typically contains the sizing agent at a concentration ranging from 0.2% by mass to 20% by mass.

Examples of the method of applying a sizing agent onto carbon fibers (the method of coating carbon fibers with a sizing agent) include a method of immersing carbon fibers in a sizing agent-containing liquid through a roller, a method of bringing carbon fibers into contact with a roller onto which a sizing agent-containing liquid adheres, and a method of spraying a sizing agent-containing liquid onto carbon fibers. The method of applying a sizing agent may be either a batch-wise manner or a continuous manner, and the continuous manner is preferably employed due to good productivity and small variation. During the application, in order to uniformly apply an active component in the sizing agent onto carbon fibers within an appropriate amount, the concentration and temperature of a sizing agent-containing liquid, the thread tension, and other conditions are preferably controlled. During the application of a sizing agent, carbon fibers are preferably vibrated by ultrasonic waves.

During the coating of carbon fibers with the sizing solution, the sizing agent-containing liquid preferably has a liquid temperature ranging from 10 to 50° C. in order to suppress a concentration change of the sizing agent due to the evaporation of a solvent. Furthermore, by adjusting a throttle for extracting an excess sizing agent-containing liquid after applying the sizing agent-containing liquid, the adhesion amount of the sizing agent can be controlled, and the sizing agent can be uniformly infiltrated into carbon fibers.

After coated with a sizing agent, the carbon fibers are preferably heated to a temperature ranging from 160 to 260° C. for 30 to 600 seconds. The heat treatment conditions are more preferably to a temperature ranging from 170 to 250° C. for 30 to 500 seconds and particularly preferably to a temperature ranging from 180 to 240° C. for 30 to 300 seconds. Without wishing to be bound by any particular theory, heat treatment under conditions at lower than 160° C. and/or for less than 30 seconds fail to accelerate the interaction between the reactive component (A) which may comprise for example an aliphatic epoxy compound in the sizing agent and an oxygen-containing functional group on the surface of carbon fibers, and this may result in insufficient adhesion between the carbon fibers and a matrix resin. Alternatively or in addition, this lower temperature may insufficiently dry the carbon fibers and insufficiently remove any solvent. Heat treatment under conditions at higher than 260° C. and/or for more than 600 seconds may cause the sizing agent to decompose and volatilize and thus these higher temperatures may fail to accelerate the interaction with carbon fibers, and this may result in insufficient adhesion between the carbon fibers and a matrix resin, again, without wishing to be bound to any particular theory.

The heat treatment can be performed by microwave irradiation and/or infrared irradiation. When sizing agent-coated carbon fibers are treated with heat by microwave irradiation and/or infrared irradiation, microwaves enter the carbon fibers and are absorbed by the carbon fibers, and this can heat the carbon fibers as an object to be heated to an intended temperature in a short period of time. The microwave irradiation and/or the infrared irradiation can rapidly heat the inside of the carbon fibers. This can reduce the difference in temperature between the inner side and the outer side of carbon fiber bundles, thus reducing the uneven adhesion of a sizing agent.

In the present invention, the amount of the sizing agent on the carbon fibers is preferably in a range from 0.1 to 10.0% by mass and more preferably from 0.2 to 3.0% by mass relative to the sizing agent-coated carbon fibers. If coated with the sizing agent in an amount of 0.1% by mass or more, the sizing agent-coated carbon fibers can withstand friction with metal guides or the like through which the carbon fibers pass while preparing a prepreg and weaving, and this prevents fluffs from generating; thus producing a carbon fiber sheet having excellent quality such as smoothness. If the adhesion amount of the sizing agent is 10.0% by mass or less, a matrix resin can infiltrate into carbon fibers without interference by a sizing agent coating around the sizing agent-coated carbon fibers. This prevents voids from generating in an intended composite material, and thus the composite material has excellent quality and excellent mechanical characteristics.

The adhesion amount of the sizing agent is a value (% by mass) calculated by weighing about 2±0.5 g of sizing agent-coated carbon fibers, subjecting the carbon fibers to heat treatment at 450° C. for 15 minutes in a nitrogen atmosphere, determining the change in mass before and after the heat treatment, and dividing the change in mass by the mass before the heat treatment.

In certain embodiments of the present invention, the sizing agent layer applied onto carbon fibers and dried preferably has a thickness ranging from 2.0 to 20 nm and a maximum thickness of less than twice a minimum thickness. A sizing agent layer having such a uniform thickness can stably achieve a large adhesion improvement effect and can stably achieve excellent high-order ease of processing.

### Coating Method

In an embodiment, if the reactive component (A) includes compounds that are capable of polymerizing are monomeric), the sizing agent-coated carbon fibers of the present invention can be obtained by heating the carbon fibers coated with the reactive component (A) having the functional groups (i) capable of reacting with the high heat-resistant thermosetting resin composition (B) and polymerizing the monomers. Specifically, the monomers may be coated on a carbon fiber bundle, and then the carbon fiber bundle is preliminarily dried by a heating roller. Moreover, it is primarily dried using a hot air dryer, and then the monomer is thermally polymerized, After the monomer is coated on the carbon fiber bundle, the fiber bundle can be simultaneously spread and fixed by the preliminarily drying using the heating roller. Furthermore, it is preferable to carry out the primary drying and the thermal polymerization simultaneously since the obtained carbon fiber bundle can be kept flexible. If flexibility can be ensured, the preliminary drying can also be omitted.

The sizing agent-coated carbon fibers of the present invention are used in shapes, for example, tows, woven fabrics, knits, braids, webs, mats, and chopped strands. In particular, for an application necessitating high specific strength and specific modulus, a tow prepared by arranging carbon fibers in one direction is most preferred, and a prepreg prepared by further impregnation with the high heat-resistant thermosetting resin composition (B) is preferably used.

### High Heat Resistant Thermosetting Resin Composition (B)

The high heat-resistant thermosetting resin composition (B) used in the present invention is comprised of at least one thermosetting resin other than an epoxy resin, There are no specific limitations or restrictions on the types of the thermosetting resin other than not including an epoxy resin, used in the present invention, as long as it can undergo cross-linking reaction by heat and at least partially form a three-dimensional cross-linked structure, Examples of such a thermosetting resin include unsaturated polyester compounds, vinyl ester compounds, bismaleimide compounds, benzoxazine compounds, phenol compounds, urea compounds, melamine compounds, and thermosetting polyimide compounds and also Include modified compounds thereof and blending resins of two or more of these. The term “high heat-resistant” as used herein means a resin that when cured, has a glass transition temperature of 220° C. or more.

### Cured Resin Tg

The high heat-resistant thermosetting resin composition (B) has also a glass transition temperature (Tg) of 220° C. or more after being cured. In other embodiments, the Tg is preferably 240° C. or more and more preferably 260° C. or more. The Tg can be determined by the G′ onset method (described in more detail in the Examples) with a dynamic viscoelasticity measuring device (ARES, manufactured by TA Instruments). If the Tg is 220° C. or more, the sizing agent-coated carbon fiber reinforced composite material produced from the prepreg of the present invention will have high thermal performance at higher temperatures.

In certain embodiments, the cure profile is not particularly limited, as long as the effect of the invention is not deteriorated. If a higher Tg is desired, the high heat-resistant thermosetting resin composition (B) can be cured at higher temperature.

### Bismaleimide Resin Composition

The bismaleimide resin compositions in accordance with the present invention can include a bismaleimide compound (B-1), co-monomer (C), thermoplastic toughening agent and a resin stabilizer. The bismaleimide compound (B-1) combination is preferably, but not necessarily, a eutectic mixture. A eutectic mixture is one where the melting point of the mixture is at a minimum and less than the melting point of the individual bismaleimide compounds (B-1). There may be several different bismaleimide compounds (B-1) in the eutectic mixture. In an embodiment, the number of bismaleimide compounds (B-1) be three. The bismaleimide compound (B-1) combinations are selected to provide a prepreg matrix resin that is amorphous after cure. “Amorphous” means that the bismaleimide resin composition is less than 5 percent crystalline. It is preferred that the bismaleimide resin composition be at least 97 percent amorphous (i.e. no more than 3 percent crystalline). Even more preferred are mixtures that are at least 99 percent amorphous (i.e. no more than 1 percent crystalline). The degree of crystallization of the resin is determined by routine measurements, such as differential scanning calorimetry, which are well known in the art.

### Bismaleimide Compound (B-1)

The bismaleimide compound (B-1) used in the present invention includes any of the known bismaleimide compounds. The bismaleimide compounds (B-1) are typically prepared by reacting maleic anhydride or substituted maleic anhydrides with aromatic and/or aliphatic diamines. Exemplary bismaleimides are as follows: N,N′-4,4′-diphenylmethane-bis-maleimide; N,N′-2,4-toluene-bis-maleimide; N,N′-2,6-toluene-bis-maleimide; N,N′-2,2,4-trimethylhexane-bis-maleimide; N,N′-ethylene-bis-maleimide; N,N′-ethylene-bis(2-methyl)maleimide; N,N′-trimethylene-bis-maleimide; N,N′-tetramethylene-bis-maleimide; N,N′-hexamethylene-bis-maleimide; N,N′-1,4-cyclohexylene-bis-maleimide; N,N′-meta-phenylene-bis-maleimide; N,N′-para-phenylene-bis-maleimide; N,N′-4,4′-3,3′-dichloro-diphenylmethane-bis-maleimide; N,N′-4,4′-diphenyl-ether-bis-maleimide; N,N′-4,4′-diphenylsulfone-bis-maleimide; N,N′-4.4′-dicyclohexylmethane-bis-maleimide; N,N′-α,α′-4.4′-dimethylenecyclohexane-bis-maleimide; N,N′-meta-xylene-bis-maleimide; N,N′-para-xylene-bis-maleimide; N, N′-4,4′-diphenyl-cyclohexane-bis-maleimide; N,N′-meta-phenylene-bis-tetrahydrophthalimide; N,N′-4,4′-diphenylmethane bis-citraconimide; N,N′-4,4′-2,2-diphenylpropane-bis-maleimide; N,N′-4,4-1,1-diphenyl-propane-bis-maleimide; N,N′-4,4′-triphenylmethane-bis-maleimide; N,N′-α,α′-1,3-dipropylene-5,5-dimethyl-hydantoin-bis-maleimide; N,N′-4,4′-(1,1,1-triphenyl ethane)-bis-maleimide; N,N′-3,5-triazole-1,2,4-bis-maleimide; N,N′-4,4′-diphenylmethane-bis-itaconimide; N,N′-para-phenylene-bis-itaconimide; N,N′-4,4′-diphenylmethane-bis dimethyl-maleimide; N,N′-4,4′-2,2-diphenylpropane-bis-dimethyl-maleimide; N,N′-hexamethylene-bis-dimethyl-maleimide; N,N′-4,4′-(diphenyl ether)-bis-dimethyl-maleimide; N,N′-4,4′-diphenylsulphone-bis-dimethylmaleimide; N,N′-(oxydi-para-phenylene)-bis-maleimide; N,N′-(oxydi-para-phenylene)-bis-(2-methylmaleimide); N,N′-(methylene di-para-phenylene)-bis-maleimide; N,N′-(methylene di-para-phenylene)-bis-(2-methylmaleimide); N,N′(methylene di-para-phenylene)-bis-(2-phenylmaleimide); N,N′-(sulfonyl di-para-phenylene)-bis-maleimide; N,N′-(thio di-para-phenylene)-bis-maleimide; N,N′-(dithio di-para-phenylene)-bis-maleimide; N,N′-(sulfonyl di-meta-phenylene)-bis-maleimide; N,N′-(ortho, para-isopropylidene diphenylene)-bis-maleimide; N,N′-(isopropylidene di-para-phenylene)-bis-maleimide; N,N′-(ortho, para-cyclohexylidene diphenylene)-bis-maleimide; N,N′-(cyclohexylidene di-para-phenylene)-bis-maleimide; N,N′-(ethylene di-para-phenylene)-bis-maleimide; N,N′-(4,4″-para-triphenylene)-bis-maleimide; N,N′-(para-phenylenedioxy-di-para-phenylene)-bis-maleimide; N,N′-(methylene di-para-phenylene)-bis-(2,3-dichloromaleimide); N,N′-(oxy-di-para-phenylene)-bis-(2-chloromaleimide), and mixtures thereof.

The specific combination of three or more bismaleimide compounds that is used to make the bismaleimide resin composition may be varied widely provided that an amorphous, and preferably eutectic, mixture is provided that, once the co-monomer (C), (optional) thermoplastic toughening agent and (optional) resin distribution stabilizer have been added, has the necessary flexibility, tack and curing properties required for use as a prepreg resin.

Suitable mixtures of three or more bismaleimides are available commercially. For example, Compimide® 353A is a mixture of N,N′-4,4′-diphenylmethane-bis-maleimide, N,N′-2,4-toluene-bis-maleimide and N,N′-2,2,4-trimethylhexane-bis-maleimide that is available from Evonik Industries AG. Compimide® 353A is a preferred eutectic mixture of bismaleimide monomers.

### Co-Monomer (C)

The co-monomer (C) used in the present invention includes any of the co-monomers typically combined with bismaleimides. Exemplary co-monomers include diamines, polyamines and alkenyl aromatic compounds, such as alkenylphenols and alkenylphenoxyethers. Preferred co-monomers are alkenylphenols, such as the allyl, methallyl and propenyl phenols. Specific examples include o,o′-diallylbisphenol A, eugenol, eugenol methylether and similar compounds, as disclosed in U.S. Pat. No. 4,100,140, the contents of which are incorporated herein for all purposes. Particularly preferred co-monomers are o,o′-diallylbisphenol A and o,o′-dipropenylbisphenol A. Compimide® TM124 is a commercially available co-curing agent that is available from Evonik Industries AG, which contains o,o′-diallyl bisphenol A.

In an embodiment, the co-monomer (C) has at least one vinyl group and at least one group selected from hydroxyl group and thiol group. Not to be bound by theory, it is thought that the co-monomer (C) having at least one vinyl group and at least one group selected from hydroxyl group and thiol group improves the adhesion properties such as ILSS (interlayer shear strength).

In another embodiment of the invention, the mole ratio of the co-monomer (C) and bismaleimide compound (B-1), defined as [(C)/(B-1)], may be from 0.2 to 0.8. In one embodiment, the lower limit of the mole ratio (C)/(B-1) is not less than 0.2, not less than 0.21, not less than 0.22, not less than 0.23, not less than 0.24, not less than not less than 0.26, not less than 0.27, not less than 0.28, not less than 0.29 or not less than 0.3. Moreover, the upper limit of the mole ratio of the [C]/[13-1]) is not more than 0.80, not more than 0.79, not more than 0.78, not more than 0.77, not more than 0.76, not more than 0.75, not more than 0.74, not more than 0.73, not more than 0.72, not more than 0.71, not more than 0.70, not more than 0.69, not more than 0.68, not more than 0.67, not more than 0.66, not more than 0.65, not more than 0.64, not more than 0.63, not more than 0.62, not more than 0.61, not more than 0.60, not more than 0.59, not more than 0.58, not more than 0.57, not more than 0.56, not more than 0.55, not more than 0.54, not more than 0.53, not more than 0.52, not more than 0.51, not more than 0.50, not more than 0.49, not more than 0.48, not more than 0.47, not more than 0.46, not more than 0.45, not more than 0.44, or not more than 0.43. Within this range, the bismaleimide resin composition will have Tg of 220° C. or more.

In other embodiment of the invention, the mole ratio of the co-monomer (C) and bismaleimide compound (B-1): [(C)/(B-1)] is 0.45 or less from the view point of improving the adhesion properties such as ILSS. In one embodiment, the mole ratio is or less, 0.43 or less, 0.42 or less, 0.41 or less, 0.40 or less, 0.39 or less, 0.38 or less, 37 or less, 0.36 or less, 0.35 or less, 0.34 or less, 0.33 or less, 0.32 or less, 0.31 or less, 0.30 or less, 0.29 or less, 0.28 or less, 27 or less, 0.26 or less, 0.25 or less, or less, 0.23 or less, 0.22 or less, or 0.21 or less.

In another embodiment of the invention, the mole ratio of the co-monomer (C) to bismaleimide compound (B-1): defined as [(C)/(B-1)] is more than 0.20 from the view point of improving Tg and the adhesion properties such as ILSS TOS. In one embodiment, the mole ratio is more than 0.25, or more than 0.30.

The inventors have found in some embodiments that these ratios may provide a final cured composite that has an interlaminar shear strength ILSS RTA after heat treatment as measured according to ASTM D2344M-16 of at least 14 ksi. According to other embodiments, these ratios may provide a cured composite having interlaminar shear strength ILSS TOS of at least 12 ksi after heat treatment according to ASTM D2344M-16. According to yet another embodiment, the cured composite may have a ratio of interlaminar shear strengths ILSS TOS/ILSS RTA of 80% after heat treatment according to ASTM D2344M-16. The details of these measurements according to ASTM D2344M-16 are set out in the Examples herein.

According to some embodiments, the mole ratio of the co-monomer (C) and bismaleimide compound (B-1) [(C)/(B-1)] may be from 0.20 to 0.45, or from 0.25 to 0.40, or from 0.30 to 0.35.

### Benzoxazine Resin Composition

The benzoxazine resin compositions in accordance with the present invention includes any of the known bismaleimide compound. In an embodiment, the benzoxazine resin composition is formed by mixing at least one benzoxazine compound (B-2) and at least one epoxy resin having certain structural features.

### Benzoxazine Compound (B-2)

The benzoxazine compound (B-2) used in the present invention includes any of the known benzoxazine compounds. In an embodiment, the benzoxazine compounds (B-2) comprises, consists essentially of or consists of at least one multifunctional benzoxazine resin containing two or more structural units as represented by general Formula (III) below.

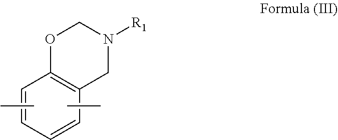

In Formula (III), R₁ denotes a linear alkyl group with a carbon number of 1 to 12, a cyclic alkyl group with a carbon number of 3 to 8, a phenyl group, or a phenyl group that is substituted with a linear alkyl group having a carbon number of 1 to 12 or a halogen, with a hydrogen being bonded to at least one of the carbon atoms at the ortho-position and the para-position with respect to a carbon atom to which an aromatic-ring oxygen atom is bonded.

In the structural unit represented by the general Formula (III) above, non-limiting examples of R₁ include a methyl group, ethyl group, propyl group, isopropyl group, n-butyl group, isobutyl group, t-butyl group, cyclopentyl group, cyclohexyl group, phenyl group, o-methylphenyl group, m-methylphenyl group, p-methylphenyl group, o-ethylphenyl group, m-ethylphenyl group, p-ethylphenyl group, o-t-butylphenyl group, m-t-butylphenyl group, p-t-butylphenyl group, o-chlorophenyl group, o-bromophenyl group, dicyclopentadiene group or benzofuranone group. Among these groups, it is preferable to use a methyl group, ethyl group, propyl group, phenyl group, or o-methylphenyl group, as the presence of such groups contributes to favorable handling properties.

The structural units represented by structural Formula (III) may be linked directly (e.g., by a single bond connecting benzene rings) or through a linker group, especially a divalent linker group such as —CH₂—, —C(CH₃)₂—, carbonyl, —S—, —SO₂—, —O—, or —CH(CH₃)—. Such divalent linker groups may bond to a carbon atom in the benzene ring of one structural unit of Formula (III) and to a carbon atom in the benzene ring of another structural unit of Formula (III). It is also possible for the structural units of structural Formula (III) to be linked through the nitrogen atoms of such structural units (involving the R₁ substituents) by means of a divalent linker group, corresponding to the general formula N-L-N where L is a divalent linker group and each N is part of an oxazine ring. For example, such a linker group may be -Ar-CH₂-Ar-, wherein Ar is a benzene ring (as illustrated in structural Formula (IIIB) and Formula (XV) below). Other suitable linker groups include -Ar-, -Ar-S-Ar-, and -Ar-O-Ar-, where Ar is a benzene ring.

Further difunctional benzoxazine resins suitable for use in the present invention include, for example, those represented by the following Formula (IA) and Formula (IIIB):

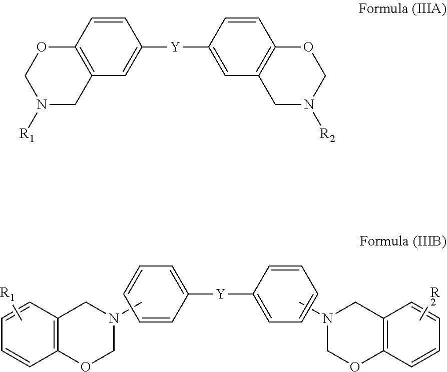

Y is selected from a direct bond, —C(R³)(R⁴)—, —C(R³)(aryl)-, —C(═O)—, —S—, —O—, —S(═O)—, —S(═O)₂—, a divalent heterocycle (e.g., 3,3-isobenzofuran-1(3h)-one) and -[C(R₃)(R₄)]ₓ-arylene-[C(R₅)(R₆)]_{y}-, or the two benzyl rings of the benzoxazine moieties may be fused.

R₁ and R₂ in Formula (IIIA) are independently selected from alkyl (e.g., C₁₋₈ alkyl), cycloalkyl (e.g., C₅₋₇ cycloalkyl, preferably C₆ cycloalkyl) and aryl, wherein the cycloalkyl and aryl groups are optionally substituted, for instance by C₁₋₈ alkyl, halogen and amine groups, and, where substituted, one or more substituent groups (preferably one substituent group) may be present on each cycloalkyl and aryl group. R₁ and R₂ in Formula (IIIB) may be independently selected from the same groups, but additionally may be hydrogen.

R₃, R₄, R₅, and R₆ are independently selected from H, C₁₋₈ alkyl (preferably C₁₋₄ alkyl, and preferably methyl), and halogenated alkyl (wherein the halogen is typically chlorine or fluorine); and x and y are independently 0 or 1. Where an arylene group is present, the arylene group is preferably phenylene. In one embodiment, the groups attached to the phenylene group may be configured in para- or meta-positions relative to each other. Where an aryl group is present, the aryl group is preferably phenyl.

The group Y may be linear or non-linear, and is typically linear. The group Y is preferably bound to the benzyl group of each of the benzoxazine moieties at the para-position relative to the oxygen atom of the benzoxazine moieties, as shown in Formula (IIIA), and this is the preferred isomeric configuration. However, the group Y may also be attached at either of the meta-positions or the ortho-position, in one or both of the benzyl group(s) in the difunctional benzoxazine compound. Thus, the group Y may be attached to the benzyl rings in a para/para; para/meta; para/ortho, meta/meta or ortho/meta configuration.

In another embodiment, the difunctional benzoxazine resin corresponding to Formula (IIIA) is selected from compounds wherein R₁ and R₂ are independently selected from aryl, preferably phenyl. In one embodiment, the aryl group may be substituted, preferably wherein the substituent(s) are selected from C₁₋₈ alkyl, and preferably wherein there is a single substituent present on at least one aryl group. C₁₋₈ alkyl includes linear and branched alkyl chains. Preferably, R₁ and R₂ in Formula (IIIA) are independently selected from unsubstituted aryl, preferably unsubstituted phenyl.

The benzyl ring in each benzoxazine group of the difunctional benzoxazine resins defined herein as Formula (IIIA) may be independently substituted at any of the three available positions of each ring, and typically any optional substituent is present at the position ortho to the position of attachment of the Y group. Preferably, however, the benzyl ring remains unsubstituted.

Suitable trifunctional benzoxazine resins include compounds that may be prepared by reacting aromatic triamines with phenols (monohydric or polyhydric) in the presence of aldehyde such as formaldehyde or a source or equivalent thereof.

In the present disclosure, it is preferable to use at least one monomer represented by the structural Formulas (III) to (XIV) below as the multifunctional benzoxazine compound (B-2).

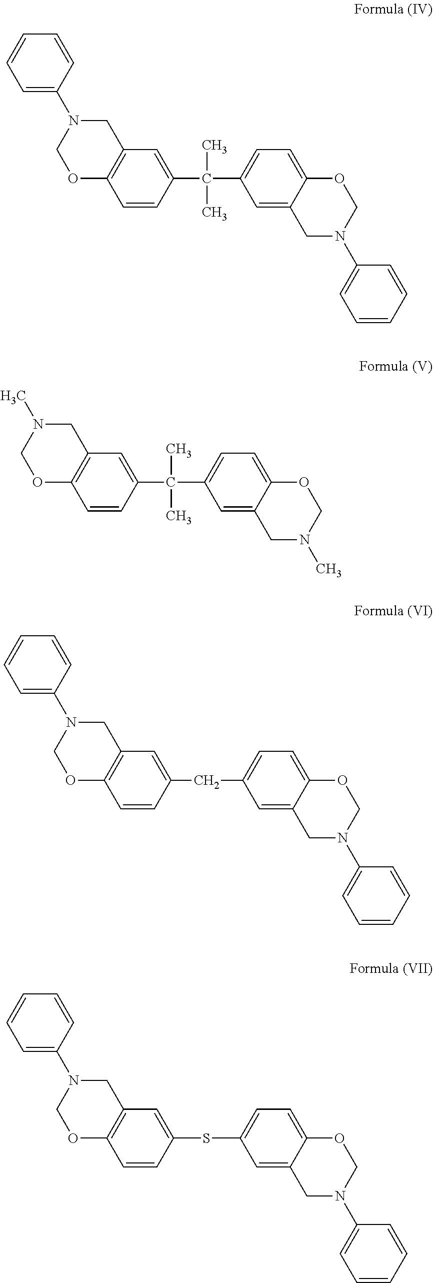

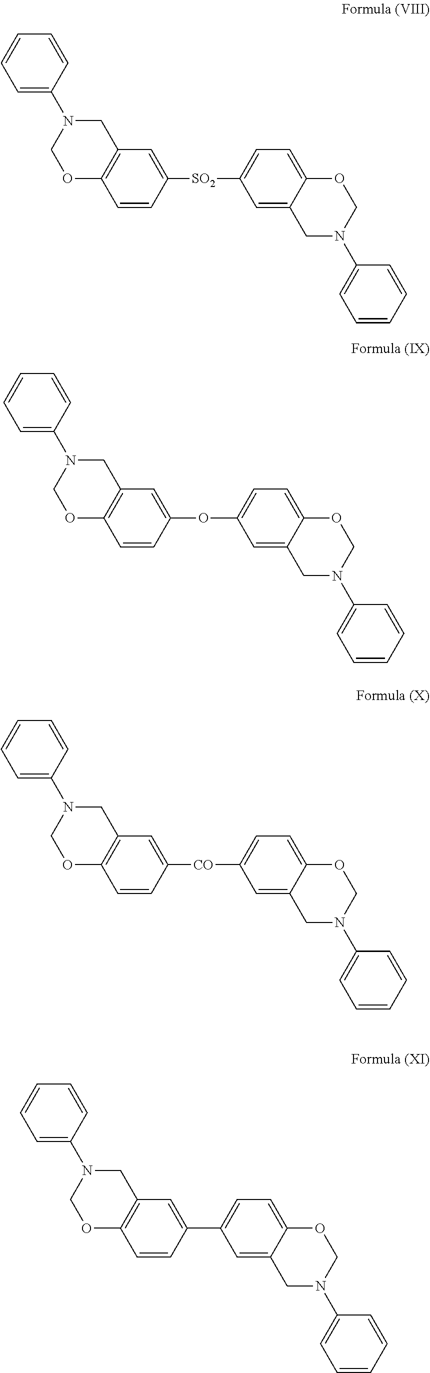 [SMILES: O=S(=O)(c1ccc2c(c1)CN(c1ccccc1)CO2)c1ccc2c(c1)CN(c1ccccc1)CO2 ; c1ccc(N2COc3ccc(Oc4ccc5c(c4)CN(c4ccccc4)CO5)cc3C2)cc1 ; O=C(c1ccc2c(c1)CN(c1ccccc1)CO2)c1ccc2c(c1)CN(c1ccccc1)CO2 ; c1ccc(N2COc3ccc(-c4ccc5c(c4)CN(c4ccccc4)CO5)cc3C2)cc1]

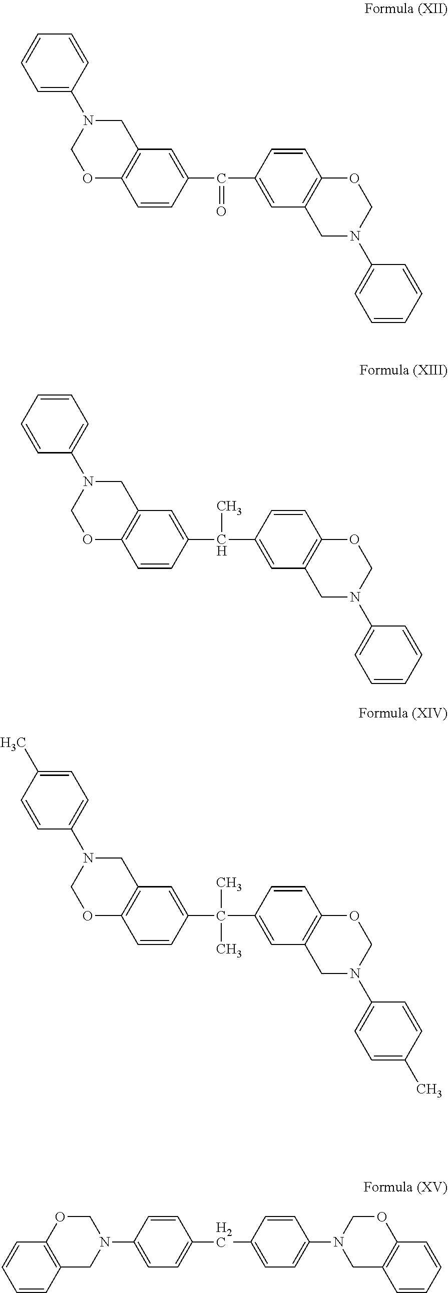 [SMILES: O=C(c1ccc2c(c1)CN(c1ccccc1)CO2)c1ccc2c(c1)CN(c1ccccc1)CO2 ; CC(c1ccc2c(c1)CN(c1ccccc1)CO2)c1ccc2c(c1)CN(c1ccccc1)CO2 ; Cc1ccc(N2COc3ccc(C(C)(C)c4ccc5c(c4)CN(c4ccc(C)cc4)CO5)cc3C2)cc1 ; c1ccc2c(c1)CN(c1ccc(Cc3ccc(N4COc5ccccc5C4)cc3)cc1)CO2]

In certain embodiments of the present invention, the benzoxazine resin composition preferably comprises (or consists essentially of or consists of) at least one multifunctional benzoxazine compound (B-2) and may be composed of monomer alone or may have the form of an oligomer in which multiple molecules are polymerized. In addition, multifunctional benzoxazine compounds (B-2) having different structures may be used together (i.e., the benzoxazine resin composition may contain two or more multifunctional benzoxazine compounds (B-2)).

The benzoxazine compound (B-2) may be procured from a number of suppliers, including Shikoku Chemicals Corp., Konishi Chemical Inc., Co., Ltd., and Huntsman Advanced Materials. Among these suppliers, Shikoku Chemicals Corp. offers a bisphenol A-aniline type benzoxazine compound, a bisphenol A methylamine type benzoxazine compound, and a bisphenol F aniline type benzoxazine compound. Rather than using commercially-available raw material, the multifunctional benzoxazine compound can be prepared, as necessary, by allowing a reaction to occur between a phenolic compound (e.g., bisphenol A, bisphenol F, bisphenol S, or thiodiphenol), an aldehyde and an arylamine. Detailed preparation methods may be found in U.S. Pat. Nos. 5,543,516, 4,607,091 (Schreiber), U.S. Pat. No. 5,021,484 (Schreiber), and U.S. Pat. No. 5,200,452 (Schreiber).

Epoxy Resin Mixed with the Benzoxazine Compound (B-2)

In the present invention, an epoxy resin that may be mixed with the benzoxazine compound (B-2) means an epoxy compound having at least two 1,2-epoxy groups within the molecule, that is to say an epoxy compound which is at least difunctional with respect to epoxy functional groups.

In certain embodiments of the present invention, the epoxy resin contains at least one cycloaliphatic epoxy resin represented by Formula (XVI), wherein R₁ and R₂ are the same or different and are each an aliphatic moiety which together with carbon atoms of an epoxy group form at least one aliphatic ring (in certain cases, a bicyclic aliphatic ring is formed) and X represents a single bond or a divalent moiety having a molecular weight less than 45 g/mol. In other embodiments, X is not present in Formula (XVI) and the cycloaliphatic epoxy resin comprises a fused ring system involving R₁ and R₂, such as in dicyclopentadiene diepoxide.

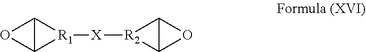

Here, a cycloaliphatic epoxy resin means an epoxy resin in which there is at least two 1,2-epoxycycloalkane structural moieties (wherein each such moiety is an aliphatic ring in which two adjacent carbon atoms which are part of the aliphatic ring also are part of an epoxy ring, each being bonded to the same oxygen atom). As previously stated, cycloaliphatic epoxy resins are useful because they can reduce the viscosity of the resin composition. However, typical cycloaliphatic epoxies, such as 3,4-epoxycyclohexylmethyl-3,4-epoxycyclohexanecarboxylate, can also reduce the glass transition temperature and modulus of the cured material. To solve this problem, cycloaliphatic epoxies with shorter, more rigid, linkages between 1,2-epoxycycloalkane groups or containing fused ring systems are employed in the present invention.

Examples of shorter, more rigid, linkages between 1,2-epoxycycloalkane groups, wherein the divalent moiety has a molecular weight less than 45 g/mole, are oxygen (X=—O—), sulfur (X=—S—), alkylene (e.g., X=—CH₂—, —CH₂CH₂—, —CH₂CH₂CH₂—, —CH₂CH(CH₃)— or —C(CH₃)₂—), an ether-containing moiety (e.g., X=—CH₂OCH₂—), a carbonyl-containing moiety (e.g., X=—C(═O)—), or an oxirane ring-containing moiety (e.g., X=—CH—O—CH—, wherein a single bond exists between the two carbon atoms thereby forming a three-membered ring including the oxygen atom and the two carbon atoms).

In certain embodiments, X in Formula (XVI) is not present, meaning that R₁ and R₂ are part of a fused ring system. Dicyclopentadiene diepoxide is an example of a cycloaliphatic epoxy resin in which R₁ and R₂ are part of a fused ring system. In other embodiments, X in Formula (XVI) is a single bond which connects cyclic groups containing R₁ and R₂.

The cycloalkane groups present in such cycloaliphatic epoxy resins may, for example, be monocyclic or bicyclic (e.g., a norbornane group). Examples of suitable monocyclic cycloalkane groups include, but are not limited to, cyclohexane groups and cyclopentane groups. Such cycloalkane groups may be substituted (for example, with alkyl groups) or, preferably, unsubstituted. Where X is a single bond or a divalent moiety having a molecular weight less than 45 g/mole, the epoxy groups on such cyclohexane and cyclopentane rings may be present at the 2,3 or 3,4 positions on the rings.

Employing a cycloaliphatic epoxy with an aforementioned single bond, a divalent moiety having a molecular weight less than 45 g/mole, or a fused ring system is advantageous, as the molecule's rigidity increases the modulus of the cured material. Furthermore, including a divalent moiety that meets the previously mentioned criteria but is also capable of forming a covalent bond with other components of the resin formulation (for example, where X is an oxirane ring-containing moiety) is advantageous since increasing the crosslink density can improve both the glass transition temperature and modulus of the cured material.

Specific illustrative examples of cycloaliphatic epoxy resins used in the present invention are bis(3,4-epoxycyclohexyl) (where Y is a single bond, also referred to as 3,4,3′,4′-diepoxybicyclohexyl); bis[(3,4-epoxycyclohexyl)ether] (where Y is an oxygen atom), bis[(3,4-epoxycyclohexyl)oxirane] (where Y is an oxirane ring, —CH—O—CH—), bis[(3,4-epoxycyclohexyl)methane] (where Y is methylene, CH₂), 2,2-bis(3,4-epoxycyclohexyl)propane (where Y is —C(CH₃)₂—) and the like and combinations thereof.

In addition, mono and bi cyclopentane substituted versions of the aforementioned monomers including bis(3,4-epoxycyclopentyl), bis(3,4-epoxycyclopentyl) ether and 3,4-epoxycyclopentyl-3,4-epoxycyclohexyl, may be employed.

### Thermoplastic

In certain embodiments of the present invention, mixing or dissolving at least one thermoplastic compound into the above-mentioned high heat-resistant thermosetting resin composition may also be desirable to enhance the properties of the cured material and to increase the minimum viscosity during curing to improve processing characteristics. In general, a thermoplastic compound (polymer) having bonds selected from the group consisting of carbon-carbon bonds, amide bonds, imide bonds, ester bonds, ether bonds, carbonate bonds, urethane bonds, thioether bonds, sulfone bonds and/or carbonyl bonds in the main chain of the thermoplastic compound (polymer) is preferred. Further, the thermoplastic compound can also have a partially cross-linked structure and may be crystalline or amorphous. In particular, it is suitable or preferred that at least one thermoplastic compound selected from the group consisting of polyamides, polycarbonates, polyacetals, polyphenylene oxides, polyphenylene sulfides, polyallylates, polyesters, polyamideimides, polyimides (including polyimides having a phenyltrimethylindane or phenylindane structure), polyetherimides, polysulfones, polyethersulfones, polyetherketones, polyetheretherketones, polyaramids, polyethernitriles and polybenzimidazoles is mixed or dissolved into the high heat-resistant thermosetting matrix resin composition (B). In the case of a polyimide thermoplastic compound, the thermoplastic compound's backbone may additionally contain phenyltrimethylindane or phenylindane units.

In certain embodiments of the present invention, the glass transition temperature (Tg) of the thermoplastic is 150° C. or greater so that favorable heat resistance is obtained, with 170° C. or greater being preferred, with 200° C. or greater being more preferred, with 220° C. or greater being particularly preferred. If the glass transition temperature of the thermoplastic that is blended is less than 150° C., the resulting moldings will tend to suffer thermal deformation during use. From the standpoint of producing high heat resistance or high solvent resistance, or from the standpoint of affinity with respect to the high heat-resistant thermosetting resin composition, including solubility and adhesion, it is preferable to use a polysulfone, polyethersulfone, polyphenylene sulfide, polyimide (including polyimides having a phenyltrimethylindane or phenylindane structure), or polyetherimide.

Specific examples of suitable sulfone-based thermoplastic compounds include, but are not limited to, polyethersulfones and the polyethersulfone-polyetherethersulfone copolymer oligomers as described in US 2004/044141 A1, the contents of which is incorporated by reference herein for all purposes. Specific examples of suitable imide-based thermoplastic compounds include, but are not limited to, polyimides and the polyimide-phenyltrimethylindane oligomers as described in U.S. Pat. No. 3,856,752, the contents of which is incorporated by reference herein for all purposes.

As used herein, the term oligomer refers to a polymer with a relatively low molecular weight in which a finite number of approximately ten to approximately 100 monomer molecules are bonded to each other. In an embodiment, the thermoplastic compound is an oligomer.

The molecular weight of the thermoplastic compound is preferably a weight-average molecular weight of 150,000 g/mole or less. More preferably, the weight-average molecular weight is 7,000 to 150,000 g/mol. The weight average molecular weight is measured using gel permeation chromatography as described below. If less than 7,000 g/mole, the effect of improvement in physical properties will be slight, and the heat resistance of the high heat-resistant thermosetting resin composition will suffer. If Mw of the thermoplastic compound is greater than 150,000 g/mole, compatibility with the high heat-resistant thermosetting resin composition will be poor, and no improvement in physical properties will be obtained in the curable or cured high heat-resistant thermosetting resin composition or the sizing agent coated-carbon fiber reinforced composite material. In addition, when dissolved, the viscosity will be too high even when blended in small amounts, and the tackiness and draping properties will decline when producing prepregs. When the thermoplastic having a weight-average molecular weight of 7,000 to 150,000 g/mole is used, this has the effect of improving compatibility with the high heat-resistant thermosetting resin composition and of improving physical properties without compromising the heat resistance of high heat-resistant thermosetting resin composition. Moreover, suitable tackiness and draping properties are provided when producing prepregs.

Weight-average and number-average molecular weight of components used in this invention can be obtained by gel permeation chromatography (“GPC” below). The number-average molecular weight of a monomer corresponds to a molecular weight of one monomer unit. Examples of the method for measuring the weight-average and the number-average molecular weight include a method wherein two Shodex 80M® [columns] (manufactured by Showa Denko) and one Shodex 802® [column] (manufactured by Showa Denko) are used, 0.3 μL of sample is injected, and the retention time of the sample measured at a flow rate of 1 mL/min is converted to molecular weight by utilizing the retention time of a calibration sample composed of polystyrene. When multiple peaks are observed in liquid chromatography, the target components are separated beforehand by liquid chromatography, and each component is then subjected to GPC, followed by molecular weight conversion.

Although the high heat-resistant thermosetting resin composition need not contain a thermoplastic compound, in various embodiments of the invention the high heat-resistant thermosetting resin composition is comprised of at least 1, at least 5, or at least 10 parts by weight of the thermoplastic compound. For example, the high heat-resistant thermosetting resin composition may be comprised of from 5 to 30 parts by weight of the thermoplastic compound per 100 parts by weight in total of high heat-resistant thermosetting resin composition.

### Other Additives

In certain embodiments, the high heat-resistant thermosetting resin composition (B) additionally comprises of, additionally consists essentially of, or additionally consists of one or more further additives. Examples of such suitable additional additives include, but are not limited to, tougheners, accelerators, reinforcing agents, fillers, adhesion promoters, flame retardants, thixotropic agents, and combinations thereof.

### Prepreg

Production of Prepreg

Next, a prepreg and a sizing agent-coated carbon fiber reinforced composite material in the present invention will be described.

In the present invention, a prepreg includes the sizing agent-coated carbon fibers described above or sizing agent-coated carbon fibers produced by the method above and the high heat-resistant thermosetting resin composition (B).

The prepreg of the present invention is prepared by impregnating sizing agent-coated carbon fiber bundles with a high heat-resistant thermosetting resin composition (B) as a matrix resin. The prepreg can be prepared, for example, by a wet method of dissolving a matrix resin in a solvent such as methyl ethyl ketone and methanol to reduce the viscosity and impregnating carbon fiber bundles with the solution and a hot melting method of heating a matrix resin to reduce the viscosity and impregnating carbon fiber bundles with the resin.

In the wet method, a prepreg is prepared by immersing sizing agent-coated carbon fiber bundles in a solution containing a matrix resin, then pulling up the carbon fiber bundles, and evaporating the solvent with an oven or other units.

In the hot melting method, a prepreg is prepared by a method of directly impregnating sizing agent-coated carbon fiber bundles with a matrix resin having a viscosity lowered by heat or a method of once preparing a coating film of a matrix resin composition on a release paper or the like, next superimposing the film on each side or one side of sizing agent-coated carbon fiber bundles, and applying heat and pressure to the film to impregnate the sizing agent-coated carbon fiber bundles with the matrix resin. The hot melting method is preferred because no solvent remains in the prepreg.

The sizing agent-coated carbon fiber cross-sectional density of a prepreg may be 50 to 1000 g/m². If the cross-sectional density is at least 50 g/m², there may be a need to laminate a small number of prepregs to secure the predetermined thickness when molding a sizing agent-coated carbon fiber reinforced composite material and this may simplify lamination work. If, on the other hand, the cross-sectional density is no more than 1000 g/m², the drapability of the prepreg may be good. The sizing agent-coated carbon fiber mass fraction of a prepreg may be 40 to 90 mass % in some embodiments, 50 to 85 mass % in other embodiments or even 60 to 80 mass % in still other embodiments. If the sizing agent-coated carbon fiber mass fraction is at least 40 mass %, there is sufficient fiber content, and this may provide the advantage of a sizing agent-coated carbon fiber reinforced composite material in terms of its excellent specific strength and specific modulus, as well as preventing the sizing agent-coated carbon fiber reinforced composite material from generating too much heat during the curing time. If the sizing agent-coated carbon fiber mass fraction is no more than 90 mass %, impregnation with the resin may be satisfactory, decreasing a risk of a large number of voids forming in the sizing agent-coated carbon fiber reinforced composite material.

The method for forming a sizing agent-coated carbon fiber reinforced composite material by using the prepreg of the present invention is exemplified by a method of stacking prepregs and thermally hardening a matrix resin while applying pressure to the laminate.

To apply heat and pressure under the prepreg lamination and molding method, the press molding method, autoclave molding method, bagging molding method, wrapping tape method, internal pressure molding method, or the like may be used as appropriate.

Autoclave molding is a method in which prepregs are laminated on a tool plate of a predetermined shape and then covered with bagging film, followed by curing, performed through the application of heat and pressure while air is drawn out of the laminate. It may allow precision control of the fiber orientation, as well as providing high-quality molded materials with excellent mechanical characteristics, due to a minimum void content. The pressure applied during the molding process may be 0.3 to 1.0 MPa, while the molding temperature may be in the 90 to 300° C. range. Due to the exceptionally high Tg of the cured benzoxazine resin composition of the present invention, it may be advantageous to carry out curing of the prepreg at a relatively high temperature (e.g., a temperature of at least 180° C. or at least 200° C.). For example, the molding temperature may be from 200° C. to 275° C. Alternatively, the prepreg may be molded at a somewhat lower temperature (e.g., 90° C. to 200° C.), demolded, and then post-cured after being removed from the mold at a higher temperature (e.g., 200° C. to 275° C.).

The wrapping tape method is a method in which prepregs are wrapped around a mandrel or some other cored bar to form a tubular sizing agent-coated carbon fiber reinforced composite material. This method may be used to produce golf shafts, fishing poles and other rod-shaped products. In more concrete terms, the method involves the wrapping of prepregs around a mandrel, wrapping of wrapping tape made of thermoplastic film over the prepregs under tension for the purpose of securing the prepregs and applying pressure to them. After curing of the resin through heating inside an oven, the cored bar is removed to obtain the tubular body. The tension used to wrap the wrapping tape may be 20 to 100 N. The molding temperature may be in the 80 to 300° C. range.

The internal pressure forming method is a method in which a preform obtained by wrapping prepregs around a thermoplastic resin tube or some other internal pressure applicator is set inside a metal mold, followed by the introduction of high pressure gas into the internal pressure applicator to apply pressure, accompanied by the simultaneous heating of the metal mold to mold the prepregs. This method may be used when forming objects with complex shapes, such as golf shafts, bats, and tennis or badminton rackets. The pressure applied during the molding process may be 0.1 to 2.0 MPa. The molding temperature may be between room temperature and 300° C. or in the 180 to 275° C. range.

The sizing agent-coated carbon fiber reinforced composite material produced from the prepreg of the present invention may have a class A surface as mentioned above. The term “class A surface” means a surface that exhibits extremely high finish quality characteristics free of aesthetic blemishes and defects.

The sizing agent-coated carbon fiber reinforced composite materials that contain cured high heat-resistant thermosetting resin compositions (B) obtained from curing the curable high heat-resistant thermosetting resin compositions (B) according to embodiments of the present invention and the sizing agent-coated carbon fibers are advantageously used in sports applications, general industrial applications, and aeronautic and space applications. Sports applications in which these materials are advantageously used include golf shafts, fishing rods, tennis or badminton rackets, hockey sticks and ski poles. General industrial applications in which these materials are advantageously used include structural materials for vehicles, such as automobiles, bicycles, marine vessels and rail vehicles, drive shafts, leaf springs, windmill blades, pressure vessels, flywheels, papermaking rollers, roofing materials, cables, and repair/reinforcement materials.

Within this specification, embodiments have been described in a way which enables a clear and concise specification to be written, but it is intended and will be appreciated that embodiments may be variously combined or separated without departing from the invention. For example, it will be appreciated that all preferred features described herein are applicable to all aspects of the invention described herein.

In some embodiments, the invention herein can be construed as excluding any element or process step that does not materially affect the basic and novel characteristics of the composition or process. Additionally, in some embodiments, the invention can be construed as excluding any element or process step not specified herein.

Although the invention is illustrated and described herein with reference to specific embodiments, the invention is not intended to be limited to the details shown. Rather, various modifications may be made in the details within the scope and range of equivalents of the claims and without departing from the invention.

The invention may be summarized according to the following non-limiting Aspects:
Aspect 1: A prepreg comprising:
sizing agent-coated carbon fibers and a thermosetting resin composition (B) impregnated between the sizing agent-coated carbon fibers;
wherein the sizing agent comprises a reactive component (A) comprising at least three reactive groups per molecule:
(i) two or more first functional groups capable of reacting with the thermosetting resin composition (B), and
(ii) at least one second functional group different from the two or more first functional groups (i), wherein the second functional group comprises at least one of amide, imide, urethane, urea, carbonyl, ester, sulfonyl, aromatic ring, or combinations thereof;
wherein the thermosetting resin composition (B) comprises at least one thermosetting resin other than an epoxy resin and has a glass transition temperature of 220° C. or more after being cured.
Aspect 2: The prepreg according to Aspect 1, wherein the functional group (i) comprises at least one of epoxy group, vinyl group, acryloyl group, methacryloyl group, or combinations thereof.
Aspect 3: The prepreg according to Aspect 1 or Aspect 2, wherein the component (A) has the urethane group as the second functional group (ii).
Aspect 4: The prepreg according to any of Aspects 1-3, wherein the component (A) comprises three or more of the functional group (i).
Aspect 5: The prepreg according to any of Aspects 1-4, wherein the component (A) has the aromatic ring structure as functional group (ii).
Aspect 6: The prepreg according to any of Aspects 1-5, wherein the number-average molecular weight of the component (A) is less than 1,500 g/mol.
Aspect 7: The prepreg according to any of Aspects 1-6, wherein the sizing agent comprises at least one accelerator.
Aspect 8: The prepreg according to any of Aspects 1-7, wherein a surface oxygen concentration (O/C) of the carbon fibers measured by X-ray photoelectron spectroscopy is 0.12 to 0.25.
Aspect 9: The prepreg according to any of Aspects 1-8, wherein the high heat-resistant thermosetting resin composition (B) is comprised of at least one maleimide compound (B-1) and at least one co-monomer (C).
Aspect 10: The prepreg according to Aspect 9, wherein the co-monomer (C) has at least one vinyl group.
Aspect 11: The prepreg according to Aspect 9 or Aspect 10, wherein the co-monomer (C) has at least one group selected from phenol group, hydroxyl group and thiol group.
Aspect 12: The prepreg according to any of Aspects 9-11, wherein the co-monomer (C) has at least one vinyl group and at least one group selected from phenol group, hydroxyl group and thiol group.
Aspect 13: The prepreg according to any of Aspects 9-12, wherein the mole ratio of (C)/(B-1) is less than 0.5.
Aspect 14: The prepreg according to any of Aspects 9-13, wherein the mole ratio of (C)/(B-1) is more than 0.2.
Aspect 15: The prepreg according to any of Aspects 1-14, wherein the thermosetting resin composition (B) comprises at least one benzoxazine compound (B-2).
Aspect 16: The prepreg according to any of Aspects 1-15, wherein the resin composition (B) has a glass transition temperature of 240° C. or more after being cured.
Aspect 17: A carbon fiber-reinforced composite material obtained by curing a prepreg in accordance with any of Aspects 1 to 16.
Aspect 18: The carbon fiber reinforced composite material of Aspect 17, wherein the composite material has an interlaminar shear strength ILSS RTA of at least 14 ksi after heat treatment according to ASTM D2344M-16.
Aspect 19: The carbon fiber reinforced composite material of Aspect 17, wherein the composite material has an interlaminar shear strength ILSS TOS of at least 12 ksi after heat treatment according to ASTM D2344M-16.
Aspect 20: The carbon fiber reinforced composite material of Aspect 17, wherein the composite material has a ratio of interlaminar shear strengths ILSS TOS/ILSS RTA of 80% after heat treatment according to ASTM D2344M-16.

### EXAMPLES

Embodiments of the present invention are now described in more detail by way of examples. The measurement of various properties was carried out using the methods described below. These properties were, unless otherwise noted, measured under environmental conditions comprising a temperature of 23° C. and a relative humidity of 50%. Prepreg was then made from the example resins using a hot melt prepreg method. The components used in the working examples and comparative examples are as follows.

<Carbon Fibers>

Carbon Fiber CF-A (Surface Oxygen Concentration O/C: 0.15; Surface Roughness (Pa): 3.0 nm)

A copolymer made from 99% by mole of acrylonitrile and 1% by mole of itaconic add was dry-wet spun and carbonized to give carbon fibers having a total filament number of 24,000, a total fineness of 1,000 tex, a specific gravity of 1.8, a strand tensile strength of 5.9 GPa, and a strand tensile elastic modulus of 295 GPa. Next, the carbon fibers were subjected to electrolytic surface treatment to adjust the surface oxygen concentration (O/C) of 0.15. The electrolytic surface-treated carbon fibers were subsequently washed with water and dried in hot air to yield carbon fibers. The obtained carbon fibers were regarded as carbon fibers CF-A.

Carbon Fiber CF-B (Surface Oxygen Concentration O/C: 0.09; Surface Roughness (Ra): 2.9 nm)

Carbon fibers were prepared in the same manner as the carbon fiber CF-A except for electrolytic surface treatment to adjust the surface oxygen concentration (O/C) of 0.09. The obtained carbon fibers were regarded as carbon fibers CF-B.

Carbon Fiber CF-C(Surface Oxygen Concentration O/C: 0.20; Surface Roughness (Ra): 3.0 nm)

A copolymer made from 99% by mole of acrylonitrile and 1% by mole of itaconic acid was dry-wet spun and burned to give carbon fibers having a total filament number of 12,000, a total fineness of 505 tex, a specific gravity of 1.8, a strand tensile strength of 6.3 GPa, and a strand tensile elastic modulus of 330 GPa. Next, the carbon fibers were subjected to electrolytic surface treatment to adjust the surface oxygen concentration (O/C) of 0.20. The electrolytic surface-treated carbon fibers were subsequently washed with water and dried in hot air to yield carbon fibers as a raw material. The obtained carbon fibers were regarded as carbon fibers CF-C.

<Sizing Agent-Coated Carbon Fiber>

Sizing Agent-Coated Carbon Fiber CF-A with (A-1)

An aqueous emulsion containing (A-1) was prepared and applied onto the carbon fibers CF-A by immersing. The aforementioned carbon fibers were then treated with heat at a temperature of 230° C. for 60 seconds to yield sizing agent-coated carbon fiber bundles. The sizing agent content was adjusted so as to be 1.5% by mass relative to the sizing agent-coated carbon fibers.

Sizing Agent-Coated Carbon Fiber CF-A with (A-2), (A-3), (A-4), or (A-5)

An aqueous emulsion containing (A-2), (A-3), (A-4), or (A-5) was prepared and applied onto the carbon fibers CF-A by immersing. The aforementioned carbon fibers were then were then treated with hear at a temperature of 230° C. for 60 seconds to yield sizing agent-coated carbon fiber bundles. The sizing agent content was adjusted so as to be 0.5% by mass relative to the sizing agent-coated carbon fibers.

Sizing Agent-Coated Carbon Fiber CF-A with (X-1), (X-2)

An aqueous emulsion containing (X-1) or (X-2) was prepared and applied onto the carbon fibers CF-A by immersing. The aforementioned carbon fibers were then treated with heat at a temperature of 230° C. for 60 seconds to yield sizing agent-coated carbon fiber bundles. The sizing agent content was adjusted so as to be 0.5% by mass relative to the sizing agent-coated carbon fibers.

Sizing Agent-Coated Carbon Fiber CF-B with (A-1)

Sizing agent-coated carbon fibers CF-B with (A-1) were obtained in the same manner as the sizing agent-coated carbon fiber CF-A with (A-1) above except that CF-B was used as carbon fibers.

Sizing Agent-Coated Carbon Fiber CF-C with (A-1)

Sizing agent-coated carbon fibers CF-C with (A-1) were obtained in the same manner as the sizing agent-coated carbon fiber CF-A with (A-1) above except that CF-C was used as carbon fibers.

Sizing Agent-Coated Carbon Fiber CF-C with (A-2), (A-3), (A-4), or (A-5)

Sizing agent-coated carbon fibers CF-C with (A-2), (A-3), (A-4), or (A-5) were obtained in the same manner as the sizing agent-coated carbon fiber CF-A with (A-2), (A-3), (A-4), or (A-5) above except that CF-C was used as carbon fibers.

<Reactive Component (A)>
A-1 (reactive component (A) having epoxy groups and aromatic ring structure): jER™ 828 (produced by Mitsubishi Chemical Corporation), diglycidyl ether of bisphenol A, number-average molecular weight 380 g/mole
A-2 (reactive component (A) having methacryloyl groups and urethane groups): UA101H (produced by Kyoeisha Chemical), glycerol dimethacrylate hexamethylene diisocyanate, number-average molecular weight 625 g/mole
A-3 (reactive component (A) having acryloyl groups and urethane groups): UA306H (produced by Kyoeisha Chemical), pentaerythritol triacrylate hexamethylene diisocyanate, number-average molecular weight 765 g/mole
A-4 (reactive component (A) having acryloyl groups, urethane groups and aromatic ring structure): AH600 (produced by Kyoeisha Chemical), phenyl glycidyl ether acrylate hexamethylene diisocyanate, number-average molecular weight 613 g/mole
A-5 (reactive component (A) having acryloyl groups, urethane groups and aromatic ring structure): UA101T (produced by Kyoeisha Chemical), pentaerythritol triacrylate tolylene diisocyanate, number-average molecular weight 770 g/mole

<Other Compound for Sizing Agent>
X-1: Adduct of bisphenol A with 10 mole ethylene oxide
X-2: Denacol® EX-212 (produced by Nagase ChemteX Corporation), 1,6-hexanediol diglycidyl ether

<Maleimide Compounds (B-1)>
Compimide® MDAB (produced by Evonik Industries AG), N,N′-4,4′-diphenylmethane-bis-maleimide
Compimide® TDAB (produced by Evonik Industries AG), N,N′-2,4-toluene-bis-maleimide
Compimide® 353A (produced by Evonik Industries AG), N,N′-4,4′-diphenylmethane-bis-maleimide, N,N′-2,4-toluene-bis-maleimide and N,N′-2,2,4-trimethylhexane-bis-maleimide

<Co-Monomers (C)>
Compimide® TM123 (produced by Evonik Industries AG), 4,4′-bis(o-propenylphenoxy)-benzophenone
Compimide® TM124 (produced by Evonik Industries AG), o,o′-diallylbisphenol A
Compimide® TM124 ether (produced by Evonik Industries AG), 1-prop-2-enoxy-4-[2-(4-prop-2-enoxyphenyl)propan-2-yl]benzene
4,4′-DABPS (produced by DOYE PHARMA CO., LTD), 4,4′-sulfonylbis[2-(2-propenyl)]phenol

<Thermoplastic>
Matrimid® 9725 (produced by Huntsman Advanced Materials), polyimide

### (1) Strand Tensile Strength and Elastic Modulus of Carbon Fiber Bundles

The strand tensile strength and the strand elastic modulus of carbon fiber bundles were determined by the test method of resin-impregnated strand described in JIS-R-7608 (2004) in accordance with the procedure below. The resin formulation was “Celloxide®” 2021P (manufactured by Daicel Chemical Industries, Ltd.)/boron trifluoride monoethylamine (manufactured by Tokyo Chemical Industry Co., Ltd.)/acetone=100/3/4 (parts by mass), and the hardening conditions were at normal pressure at a temperature of 125° C. for 30 minutes. Ten strands of carbon fiber bundles were tested, and mean values were calculated as the strand tensile strength and the strand elastic modulus.

### (2) Surface Oxygen Concentration (O/C) of Carbon Fibers

The surface oxygen concentration (O/C) of carbon fibers was determined by X-ray photoelectron spectroscopy in accordance with the procedure below. First, a solvent was used to remove dust adhering to the surface of carbon fibers, then the carbon fibers were cut into about 20-mm pieces, and the pieces were spread on a copper sample holder. Next, the sample holder was set in a sample chamber, and the inside of the sample chamber was maintained at 1×10⁻⁸ Torr. AlKα_{1,2} was used as the X-ray source, and the measurement was carried out at a photoelectron takeoff angle of 90°. As the correction value of the peak associated with electrification during measurement, the binding energy value of the main peak (peak top) of Cis was set to 284.6 eV. The C1s peak area was determined by drawing a straight base line in a range from 282 to 296 eV. The O₁ₛ peak area was determined by drawing a straight base line in a range from 528 to 540 eV. Here, the surface oxygen concentration is determined as an atom number ratio, using a sensitivity correction value inherent in an apparatus, from the ratio of the O₁ₛ peak area and the Cis peak area. The X-ray photoelectron spectrometer used was ESCA-1600 manufactured by Ulvac-Phi, Inc., and the sensitivity correction value inherent in the apparatus was 2.33.

### (3) Determination of Sizing Agent Content

About 2 g of sizing agent-coated carbon fiber bundles were weighed (W1) (to the fourth decimal place) and then placed in an electric furnace (a volume of 120 cm 3) set at a temperature of 450° C. for 15 minutes in a nitrogen stream of 50 mL/min, and consequently the sizing agent was completely thermally decomposed. Next, the carbon fiber bundles were transferred into a container in a dry nitrogen stream of 20 liter/min, then cooled for 15 minutes, and weighed (W2) (to the fourth decimal place). The sizing agent content (wt %) was calculated in accordance with the equation, (W1−W2)/W1×100(%). The measurement was carried out twice, and the mean value was regarded as the sizing agent content.

### (4) Production of High Heat-Resistant Thermosetting Resin Composition (B)

A predetermined amount of co-monomer (C) and a thermoplastic resin were mixed in accordance with the number of blended parts and heated at 120° C. for 1 hour to dissolve the thermoplastic resin. In addition, bismaleimide compound (B-1) was separately melted at 140° C. The mixture and the bismaleimide compound (B-1) were mixed after the temperature was lowered to 100° C., and an accelerator was further added at 60° C., followed by kneading to prepare a high heat-resistant thermosetting resin composition (B). Table 1-4 summarizes the composition of various exemplary resin compositions and properties of resulting cured resins.

### (5) Production of Prepreg

A prepreg comprising the specified sizing agent-coated carbon fiber impregnated with the specified resin composition (B) was prepared. The resin composition (B) obtained in (4) above was coated onto a release paper with a knife coater to produce two sheets of resin films with a resin mass per unit area of 52 g/m². The aforementioned two sheets of fabricated resin film were overlaid on both sides of the specified sizing agent-coated carbon fiber configuration (a mass per unit area of 190 g/m²) arranged in one direction, and heat and pressure were applied with a heat roll at a temperature of 100° C. and a pressure of 1 atm to impregnate the sizing agent-coated carbon fibers with the epoxy resin composition, thus yielding a prepreg.

### (6) Curing of Prepreg

The prepreg obtained in (5) above was cut and laminated, subjected to vacuum bag molding, and cured in an autoclave with vacuum applied until the pressure exceeded 20 PSI using the following curing condition 1. 85 PSI was applied during the initial temperature ramp and was maintained for the entire cure cycle. Then it was post-cured in a convection oven using the following curing condition 2.
Curing condition 1:
1. temperature raised at a rate of 1.7° C./min from room temperature to 143° C.;
2. held for two hours at 143° C.;
3. temperature raised at a rate of 1.7° C./min from 143° C. to 190° C.;
4. held for two hours at 190° C.;
5. temperature lowered from 190° C. to 30° C. at a rate of 2° C./min.
Curing condition 2:
1. temperature raised at a rate of 1.7° C./min from room temperature to 227° C.;
2. held for four hours at 227° C.;
3. temperature lowered from 227° C. to 30° C. at a rate of 2° C./min.

### (7) Measurement of Glass Transition Temperature of Cured Resin (Tg by DMA Torsion)

The resin composition (B) prepared in (4) was dispensed into a mold cavity set for a thickness of 2 mm using a 2 mm-thick metal spacer. Then, the resin composition (B) was cured by heat treatment in a convection oven with the curing condition 1 and 2 above to obtain a 2 mm-thick cured resin plate. A test piece with a length of 50 mm and a width of 12.7 mm was cut out of the aforementioned plate and subjected to a Tg measurement in 1.0 Hz torsion mode using a dynamic viscoelasticity measuring device (ARES, manufactured by TA Instruments) by heating it to temperatures of 40° C. to 350° C. at a rate of 5° C./min in accordance with SACMA SRM 18R-94. Tg was determined by finding the intersection between the tangent line of the glass region and the tangent line of the transition region from the glass region to the rubber region on the temperature-storage elasticity modulus curve, and the temperature at that intersection was considered to be the glass transition temperature, commonly referred to as G′ onset Tg.

### (8) Measurement of Interlaminar Shear Strength at Room Temperature Ambient (ILSS RTA)

Twelve sheets of 100 mm×100 mm were cut out of the prepreg obtained in (5) and were laminated in one direction, and cured with the method (6) above, thereby providing a plate with a thickness of about 2 mm of a unidirectional carbon fiber reinforced material. A test piece with a length of 25 mm and a width of 4.5 mm was cut out of the aforementioned plate. The ILSS RTA was determined by three-point bending test in accordance with ASTM D2344M-16. The measurement was carried out at a ratio of span (L) and test piece thickness (d) L/d=4±0.3 and a crosshead speed of a bend tester of 1.27 mm/min. Five samples were subjected to the measurement, and the mean value was calculated.

(9) Measurement of Interlaminar Shear Strength after Heat Treatment (ILSS TOS)

A test piece was prepared in the same manner as (8) above and treated with heat at a temperature of 232° C. for 1000 hours in a convection oven. The ILSS TOS was determined in the same manner as ILSS RTA.

The various amounts for each example prepreg, their quality and mechanical properties of fiber reinforced composite material are summarized in Tables 1-4. Working Examples 1-15 in Tables 1-3, being embodiments of the invention, provided good quality prepreg with few fuzz, good mechanical properties and TOS.

### Working Examples 1-15 and Comparative Example 1

Comparative Example 1 utilized sizing agent-uncoated carbon fiber, while Working Examples 1-15 utilized sizing agent-coated carbon fiber using reactive compounds (A-1), (A-2), (A-3), (A-4) and (A-5), respectively. The prepreg of Comparative Example 1 had a lot of fuzz, while Working Examples 1-15 have few fuzz.

### Working Examples 1-15 and Comparative Examples 2 and 3

Comparative Examples 2 and 3 utilized sizing agent-coated carbon fiber using (X-1) [which did not contain the reactive component (A)], while Working Examples 1-utilized sizing agent-coated carbon fiber using reactive compounds (A-1), (A-2), (A-3), (A-4) and (A-5) [which contained the reactive component (A)], respectively. Working Examples 1-15 highlight the advantage of containing the reactive component (A) to ILSS RTA, ILSS TOS and ILSS TOS/ILSS RTA relative to Comparative Examples 2 and 3.

### Working Examples 1-15 and Comparative Examples 4 and 5

Comparative Examples 4 and 5 utilized sizing agent-coated carbon fiber using (X-2) [which did not contain any of the second functional group (ii) amide, imide, urethane, urea, carbonyl, ester, sulfonyl and aromatic ring structure and combinations thereof], while Working Examples 1-15 utilized sizing agent-coated carbon fiber using reactive compounds (A-1), (A-2), (A-3), (A-4) and (A-5) [which contained the aforementioned groups], respectively. Working Examples 4 and 5 highlight the advantage of containing the aforementioned groups to ILSS TOS and ILSS TOS/ILSS RTA relative to Comparative Examples 4 and 5.

### Working Examples 1, 6 and Working Examples 4, 5, 7

Working Examples 1 and 6 utilized the reactive component (A) having two functional groups, while Working Examples 4, 5, and 7 utilized the reactive component (A) having three or more of the first functional groups (i). Working Examples 4, 5, and 7 highlight the advantage of utilizing the reactive component (A) having three or more the functional groups to ILSS RTA and ILSS TOS relative to Working Examples 1 and 6.

### Working Examples 8, 11 and Working Examples 9, 10, 12

Working Examples 8 and 11 utilized the reactive component (A) having two functional groups, while Working Examples 9, 10 and 12 utilized the reactive component (A) having three or more the functional groups. Working Examples 9, 10 and 12 highlight the advantage of utilizing the reactive component (A) having three or more the functional groups to ILSS RTA and ILSS TOS relative to Working Examples 8 and 11.

### Working Examples 1 and 2, Working Examples 3 and 8

Working Examples 2 and 3 utilized sizing agent-coated carbon fiber having O/C of less than 0.12, while Working Examples 1 and 8 utilized sizing agent-coated carbon fiber having O/C of 0.12 or more. Working Examples 1 and 8 highlight the advantage of utilizing the sizing agent-coated carbon fiber having the specified O/C to ILSS RTA, ILSS TOS and ILSS TOS/ILSS RTA relative to Working Examples 2 and 3, respectively.

### Working Examples 9 and 13

Working Example 9 utilized the mole ratio of (C)/(B-1) of more than 0.45, while Working 13 utilized the mole ratio of (C)/(B-1) of 0.45 or less. Working Example 13 highlights the advantage of utilizing the specified mole ratio of (C)/(B-1) to ILSS RTA relative to Working Examples 9.

### Working Examples 13 and 16

Working Example 16 utilized the mole ratio of (C)/(B-1) of less than 0.21, while Working Example 13 utilized the mole ratio of (C)/(B-1) of 0.21 or more. Working Example 13 highlights the advantage of utilizing the specified mole ratio of (C)/(B-1) to ILSS TOS and Tg relative to Working Examples 16.

The following Tables show the Examples and the results. The following ranges apply to all of the results in the following tables.

Number of Reactive Groups Per Molecule

| | |
|---|---|
| Excellent (more preferably) | ≥4 |
| Good (preferably) | ≥3 |
| Fair (requirement) | ≥2 |
| Poor (Out of scope) | <2 |

Cured Resin Tg

| | |
|---|---|
| Excellent (more preferably) | ≥260 |
| Good (preferably) | ≥240 |
| Fair (requirement) | ≥220 |
| Poor (Out of scope) | <220 |

ILSS RTA

| | |
|---|---|
| Excellent (more preferably) | ≥18 |
| Good (preferably) | ≥16 |
| Fair (requirement) | ≥14 |
| Poor (Out of scope) | <14 |

ILSS TOS

| | |
|---|---|
| Excellent (more preferably) | ≥16 |
| Good (preferably) | ≥14 |
| Fair (requirement) | ≥12 |
| Poor (Out of scope) | <12 |

ILSS TOS/ILSS RTA

| | |
|---|---|
| Excellent (more preferably) | ≥90% |
| Good (preferably) | ≥85% |
| Fair (requirement) | ≥80% |
| Poor (Out of scope) | <80% |

TABLE 1

| | | | Unit | WE1 | WE2 | WE3 | WE4 | WE5 |
|---|---|---|---|---|---|---|---|---|
| Carbon | Type | | — | CF-A | CF-B | CF-B | CF-A | CF-A |
| fiber | O/C | | — | 0.15 | 0.09 | 0.09 | 0.15 | 0.15 |
| Sizing | Type | | — | A-1 | A-1 | A-1 | A-2 | A-3 |
| agent | Content | | % | 1.5 | 1.5 | 1.5 | 0.5 | 0.5 |
| | Number of first reactive groups | | — | 2 | 2 | 2 | 4 | 6 |
| | (i) per molecule | | | | | | | |
| Matrix | Maleimide | Compimide ® | parts | 40 | 40 | | 40 | 40 |
| resin | compound | MDAB | | | | | | |
| | (B-1) | Compimide ® | | 27 | 27 | | 27 | 27 |
| | | TDAB | | | | | | |
| | | Compimide ® | | | | 68 | | |
| | | 353A | | | | | | |
| | Co- | Compimide ® | parts | 33 | 33 | 32 | 33 | 33 |
| | monomer | TM124 | | | | | | |
| | (C) | Compimide ® | | | | | | |
| | | TM124 ether | | | | | | |
| | | Compimide ® | | | | | | |
| | | TM123 | | | | | | |
| | | 4,4′-DABPS | | | | | | |
| | Mole ratio of (C)/(B-1) | | — | 0.5 | 0.5 | 0.5 | 0.5 | 0.5 |
| | Thermoplastic | | parts | 2 | 2 | 2 | 2 | 2 |
| | MATRIMID ® 9725 | | | | | | | |
| Quality of prepreg | | | — | Good | Good | Good | Good | Good |
| Cured | Tg | | ° C. | 258 | 258 | 263 | 258 | 258 |
| resin | | | | | | | | |

| Mechanical properties | ILSS RTA | ksi | 17.6 | 17.3 | 16.5 | 18.9 | 19.1 |
|---|---|---|---|---|---|---|---|
| of CFRP | ILSS TOS | ksi | 15.8 | 15.2 | 14.6 | 16.8 | 17.0 |
| | ILSS TOS/ILSS | % | 90% | 88% | 89% | 89% | 89% |
| | RTA | | | | | | |

TABLE 2

| | | | Unit | WE6 | WE7 | WE8 | WE9 | WE10 |
|---|---|---|---|---|---|---|---|---|
| Carbon | Type | | — | CF-A | CF-A | CF-C | CF-C | CF-C |
| fiber | O/C | | — | 0.15 | 0.15 | 0.20 | 0.20 | 0.20 |
| Sizing | Type | | — | A-4 | A-5 | A-1 | A-2 | A-3 |
| agent | Content | | % | 0.5 | 0.5 | 1.5 | 0.5 | 0.5 |
| | Number of first reactive groups | | — | 2 | 6 | 2 | 4 | 6 |
| | (i) per molecule | | | | | | | |
| Matrix | Maleimide | Compimide ® | parts | 40 | 40 | | | |
| resin | compound | MDAB | | | | | | |
| | (B-1) | Compimide ® | | 27 | 27 | | | |
| | | TDAB | | | | | | |
| | | Compimide ® | | | | 68 | 68 | 68 |
| | | 353A | | | | | | |
| | Co- | Compimide ® | parts | 33 | 33 | 32 | 32 | 32 |
| | monomer | TM124 | | | | | | |
| | (C) | Compimide ® | | | | | | |
| | | TM124 ether | | | | | | |
| | | Compimide ® | | | | | | |
| | | TM123 | | | | | | |
| | | 4,4′-DABPS | | | | | | |
| | Mole ratio of (C)/(B-1) | | — | 0.5 | 0.5 | 0.5 | 0.5 | 0.5 |
| | Thermoplastic | | parts | 2 | 2 | 2 | 2 | 2 |
| | MATRIMID ® 9725 | | | | | | | |
| Quality of prepreg | | | — | Good | Good | Good | Good | Good |
| Cured | Tg | | ° C. | 258 | 258 | 263 | 263 | 263 |
| resin | | | | | | | | |

| Mechanical properties | ILSS RTA | ksi | 16.1 | 19.1 | 16.8 | 17.7 | 17.9 |
|---|---|---|---|---|---|---|---|
| of CFRP | ILSS TOS | ksi | 14.6 | 17.4 | 15.1 | 15.1 | 15.2 |
| | ILSS TOS/ILSS | % | 91% | 91% | 90% | 85% | 85% |
| | RTA | | | | | | |

TABLE 3

| | | | Unit | WE11 | WE12 | WE13 | WE14 | WE15 | WE16 |
|---|---|---|---|---|---|---|---|---|---|
| Carbon | Type | | — | CF-C | CF-C | CF-C | CF-C | CF-C | CF-C |
| fiber | O/C | | — | 0.20 | 0.20 | 0.20 | 0.20 | 0.20 | 0.20 |
| Sizing | Type | | — | A-4 | A-5 | A-2 | A-2 | A-2 | A-2 |
| agent | Content | | % | 0.5 | 0.5 | 0.5 | 0.5 | 0.5 | 0.5 |
| | Number of first reactive groups | | — | 2 | 6 | 4 | 4 | 4 | 4 |
| | (i) per molecule | | | | | | | | |
| Matrix | Maleimide | Compimide ® | parts | | | | | | |
| resin | compound | MDAB | | | | | | | |
| | (B-1) | Compimide ® | | | | | | | |
| | | TDAB | | | | | | | |
| | | Compimide ® | | 68 | 68 | 78 | 66 | 68 | 84 |
| | | 353A | | | | | | | |
| | Co- | Compimide | parts | 32 | 32 | 22 | | | 16 |
| | monomer | TM124 | | | | | | | |
| | (C) | Compimide | | | | | 9 | 7 | |
| | | TM124- | | | | | | | |
| | | ether | | | | | | | |
| | | Compimide | | | | | 25 | | |
| | | TM123 | | | | | | | |
| | | 4,4′-DABPS | | | | | | 25 | |
| | Mole ratio of (C)/(B-1) | | — | 0.5 | 0.5 | 0.3 | 0.5 | 0.5 | 0.2 |
| | Thermoplastic | | parts | 2 | 2 | 2 | 2 | 2 | 2 |
| | MATRIMID ® 9725 | | | | | | | | |
| Quality of prepreg | | | — | Good | Good | Good | Good | Good | Good |
| Cured | Tg | | ° C. | 263 | 263 | 235 | 260 | 260 | 222 |
| resin | | | | | | | | | |

| Mechanical | ILSS RTA | ksi | 16.8 | 17.9 | 18.0 | 14.3 | 17.3 | 18.2 |
|---|---|---|---|---|---|---|---|---|
| properties of CFRP | ILSS TOS | ksi | 14.6 | 15.6 | 15.5 | 12.6 | 15.1 | 14.5 |
| | ILSS TOS/ILSS | % | 87% | 87% | 86% | 88% | 87% | 80% |
| | RTA | | | | | | | |

TABLE 4

| | | | Unit | CE1 | CE2 | CE3 | CE4 | CE5 |
|---|---|---|---|---|---|---|---|---|
| Carbon | Type | | — | CF-A | CF-A | CF-A | CF-A | CF-A |
| fiber | O/C | | — | 0.15 | 0.15 | 0.15 | 0.15 | 0.15 |
| Sizing | Type | | — | — | X-1 | X-1 | X-2 | X-2 |
| agent | Content | | % | — | 0.5 | 0.5 | 0.5 | 0.5 |
| | Number of first reactive groups | | Pieces/ | — | 0 | 0 | 2 | 2 |
| | (i) per molecule | | molecule | | | | | |
| Matrix | Maleimide | Compimide ® | parts | 40 | 40 | | 40 | |
| resin | compound | MDAB | | | | | | |
| | (B-1) | Compimide ® | | 27 | 27 | | 27 | |
| | | TDAB | | | | | | |
| | | Compimide ® | | | | 65 | | 68 |
| | | 353A | | | | | | |
| | Co- | Compimide ® | parts | 33 | 33 | 35 | 33 | 32 |
| | monomer | TM124 | | | | | | |
| | (C) | Compimide | | | | | | |
| | | TM124 ether | | | | | | |
| | | Compimide ® | | | | | | |
| | | TM123 | | | | | | |
| | | 4,4′-DABPS | | | | | | |
| | Mole ratio of (C)/(B-1) | | — | 0.5 | 0.5 | 0.5 | 0.5 | 0.5 |
| | Thermoplastic | MATRIMID ® | parts | 2 | 2 | 2 | 2 | 2 |
| | | 9725 | | | | | | |
| Quality of prepreg | | | | Poor | Good | Good | Good | Good |
| Cured | Tg | | ° C. | 258 | 258 | 263 | 258 | 263 |
| resin | | | | | | | | |

| Mechanical properties | ILSS RTA | ksi | 18.0 | 13.3 | 12.7 | 17.8 | 16.9 |
|---|---|---|---|---|---|---|---|
| of CFRP | ILSS TOS | ksi | 16.5 | 12.1 | 11.6 | 11.0 | 10.5 |
| | ILSS TOS/ILSS | % | 92% | 91% | 91% | 62% | 62% |
| | RTA | | | | | | |

We would have expected that ILSS RTA would be improved when specific carbon fiber described in claim was used. Instead we found that when this specific carbon fiber and a thermosetting resin composition having a Tg of 220° C. or more after being cured are combined as described in claim, ILSS TOS was improved in addition to ILSS RTA, and ILSS TOS/ILSS RTA was also increased. We were surprised that this invention could achieve both high ILSS RTA, ILSS TOS and ILSS TOS/ILSS RTA.

1. A prepreg comprising:
sizing agent-coated carbon fibers and a thermosetting resin composition (B) impregnated between the sizing agent-coated carbon fibers;
wherein the sizing agent comprises a reactive component (A) comprising at least three reactive groups per molecule:
(i) two or more first functional groups capable of reacting with the thermosetting resin composition (B), and
(ii) at least one second functional group different from the two or more first functional groups (i), wherein the second functional group comprises at least one of amide, imide, urethane, urea, carbonyl, ester, sulfonyl, aromatic ring, or combinations thereof;
wherein the thermosetting resin composition (B) comprises at least one thermosetting resin other than an epoxy resin and has a glass transition temperature of 220° C. or more after being cured.

2. The prepreg according to claim 1, wherein the functional group (i) comprises at least one of epoxy group, vinyl group, acryloyl group, methacryloyl group, or combinations thereof.

3. The prepreg according to claim 1, wherein the component (A) has the urethane group as the second functional group (ii).

4. The prepreg according to claim 1, wherein the component (A) comprises three or more of the functional group (i).

5. The prepreg according to claim 1, wherein the component (A) has the aromatic ring structure as functional group (ii).

6. The prepreg according to claim 1, wherein the number-average molecular weight of the component (A) is less than 1,500 g/mol.

7. The prepreg according to claim 1, wherein the sizing agent comprises at least one accelerator.

8. The prepreg according to claim 1, wherein a surface oxygen concentration (O/C) of the carbon fibers measured by X-ray photoelectron spectroscopy is 0.12 to 0.25.

9. The prepreg according to claim 1, wherein the high heat-resistant thermosetting resin composition (B) is comprised of at least one maleimide compound (B-1) and at least one co-monomer (C).

10. The prepreg according to claim 9, wherein the co-monomer (C) has at least one vinyl group.

11. The prepreg according to claim 9, wherein the co-monomer (C) has at least one group selected from phenol group, hydroxyl group and thiol group.

12. The prepreg according to claim 9, wherein the co-monomer (C) has at least one vinyl group and at least one group selected from phenol group, hydroxyl group and thiol group.

13. The prepreg according to claim 9, wherein the mole ratio of (C)/(B-1) is less than 0.5.

14. The prepreg according to claim 9, wherein the mole ratio of (C)/(B-1) is more than 0.2.

15. The prepreg according to claim 1, wherein the thermosetting resin composition (B) comprises at least one benzoxazine compound (B-2).

16. The prepreg according to claim 1, wherein the resin composition (B) has a glass transition temperature of 240° C. or more after being cured.

17. A carbon fiber-reinforced composite material obtained by curing a prepreg in accordance with claim 1.

18. The carbon fiber reinforced composite material of claim 17, wherein the composite material has an interlaminar shear strength ILSS RTA of at least 14 ksi after heat treatment according to ASTM D2344M-16.

19. The carbon fiber reinforced composite material of claim 17, wherein the composite material has an interlaminar shear strength ILSS TOS of at least 12 ksi after heat treatment according to ASTM D2344M-16.

20. The carbon fiber reinforced composite material of claim 17, wherein the composite material has a ratio of interlaminar shear strengths ILSS TOS/ILSS RTA of 80% after heat treatment according to ASTM D2344M-16.
